(19) United States
(12) Patent Application Publication
(10) Pub. No.: US 2023/0223016 A1
(43) Pub. Date: Jul. 13, 2023

(54) USER INTERFACE LINKING ANALYZED SEGMENTS OF TRANSCRIPTS WITH EXTRACTED KEY POINTS

(71) Applicant: Abridge AI, Inc., Pittsburgh, PA (US)

(72) Inventors: Sandeep Konam, Pittsburgh, PA (US); Shivdev Rao, Pittsburgh, PA (US)

(73) Assignee: Abridge AI, Inc., Pittsburgh, PA (US)

(21) Appl. No.: 18/092,598

(22) Filed: Jan. 3, 2023

Related U.S. Application Data
(60) Provisional application No. 63/296,235, filed on Jan. 4, 2022.

(51) Int. Cl. G10L 15/18; G06F 40/134; G06F 16/35

(52) U.S. Cl. CPC G10L 15/1815; G06F 40/134; G06F 16/35

(57) ABSTRACT

A user interface (UI) linking analyzed segments of transcripts with extracted key points may be provided by capturing audio of a conversation including first and second pluralities of utterances respectively spoken by first and second parties; transmitting the audio to a Natural Language Processing (NLP) system; receiving a transcript of the conversation and analysis outputs from the transcript including a key point and hyperlink to a most-semantically-relevant segment of a plurality of segments included in the transcript for the key point according to a semantic context for the key point within the conversation; displaying, in a UI, the transcript and a selectable representation of the key point; and in response to receiving a selection of the selectable representation via the UI, adjusting display of the transcript in the UI to highlight the most-semantically-relevant segment.

### CROSS-REFERENCES TO RELATED APPLICATIONS

The present disclosure claims priority to U.S. Provisional Patent Application No. 63/296,235 filed on Jan. 4, 2022 with the title “USER INTERFACE LINKING ANALYZED SEGMENTS OF TRANSCRIPTS WITH EXTRACTED KEY POINTS”, which is incorporated herein by reference in its entirety.

### BACKGROUND

Many industries are driven by spoken conversations between parties. However, participants of these spoken conversations often mishear, forget, or misremember elements of these conversations, in addition to missing the importance of various elements within the conversation, which can lead to sub-optimal outcomes for the one or both parties. Additionally, some parties to these conversations may need to update charts, notes, or other records after having the conversations, which can be time consuming and subject to mishearing, forgetting, and misremembering the elements of the conversations, an exacerbate any difficulties in recalling the correct details of the spoken conversation.

### SUMMARY

The present disclosure is generally related to User Interface (UI) and User Experience (UX) design and implementation in conjunction with transcripts of spoken natural language conversations.

The present disclosure provides methods and apparatuses (including systems and computer-readable storage media) to interact with various Machine Learning Models (MLM) trained to convert spoken utterances to written transcripts, and output categorized elements found in the transcripts for further review and analysis via UIs. These MLMs may be used as part of a Natural Language Processing (NLP) system or as an agent for interfacing between an NLP system and a UI. As the human users interact with the UI, some or all of the operations of the MLM are exposed to the users, which provides the users with greater control over retraining or updating MLMs for specific use cases, greater confidence in the accuracy of the MLMs, and expanded functionalities for using the data output by the MLM. Accordingly, portions of the present disclosure are generally directed to increasing and improving the functionality, efficiency, and usability of the underlying computing systems and MLMs via the various methods and apparatuses described herein via an improved UI and UX.

Some embodiments of the present disclosure include a method for performing various operations, a system including a processor and a memory device including instructions that when executed by the processor perform various operations, and a memory device that includes instructions that when executed by a processor perform various operations, the operations comprising: analyzing a transcript of a conversation, by a Natural Language Processing (NLP) system, to identify a key point and a plurality of segments from the transcript that provide a semantic context for the key point within the conversation; categorizing, by the NLP system, the key point into a selected category of a plurality of categories for contextual relevance based, at least in part, on the semantic context for the key point; identifying, by the NLP system, a most-semantically-relevant segment of the plurality of segments; generating a hyperlink between the key point within the most-semantically-relevant segment of the transcript; and transmitting, to a user device, the transcript and the hyperlink.

Some embodiments of the present disclosure include a method for performing various operations, a system including a processor and a memory device including instructions that when executed by the processor perform various operations, and a memory device that includes instructions that when executed by a processor perform various operations, the operations comprising: receiving a transcript of a conversation between at least a first party and a second party, wherein the transcript includes: a key point classified within a selected semantic category of a plurality of semantic categories identified from the conversation; and a hyperlink between the key point and a most-semantically-relevant segment of a plurality of segments of the transcript; generating a display on a user interface that includes the transcript and the plurality of semantic categories, wherein the selected semantic category includes a selectable representation of the key point; and in response to receiving a selection of the selectable representation via the user interface, adjusting display of the transcript in the user interface to highlight the most-semantically-relevant segment.

Some embodiments of the present disclosure include a method for performing various operations, a system including a processor and a memory device including instructions that when executed by the processor perform various operations, and a memory device that includes instructions that when executed by a processor perform various operations, the operations capturing audio of a conversation including a first plurality of utterances spoken by a first party and a second plurality of utterance spoken by a second party; transmitting the audio to a Natural Language Processing (NLP) system; receiving, from the NLP system, a transcript of the conversation and analysis outputs from the transcript including a key point and hyperlink to a most-semantically-relevant segment of a plurality of segments included in the transcript for the key point as determined by an analysis system linked with a speech recognition system according to a semantic context for the key point within the conversation; displaying, in a User Interface (UI), the transcript and a selectable representation of the key point; and in response to receiving a selection of the selectable representation via the UI, adjusting display of the transcript in the UI to highlight the most-semantically-relevant segment.

### BRIEF DESCRIPTION OF THE DRAWINGS

The accompanying figures depict various elements of one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

It is contemplated that elements and features of one embodiment may be beneficially incorporated in the other embodiments without further recitation or illustration. For example, as the Figures may show alternative views and time periods, various elements shown in a first Figure may be omitted from the illustration shown in a second Figure without disclaiming the inclusion of those elements in the embodiments illustrated or discussed in relation to the second Figure.

FIG. 1 illustrates an example environment in which a conversation is taking place, according to embodiments of the present disclosure.

FIG. 2 illustrates a computing environment, according to embodiments of the present disclosure.

FIGS. 3A-3F illustrate interactions with a UI that includes a transcript and analysis outputs from a conversation for a first user type, according to embodiments of the present disclosure.

FIGS. 4A-4G illustrate interactions with a UI that includes a transcript and analysis outputs from a conversation for a second user type, according to embodiments of the present disclosure.

FIG. 5 is a flowchart of a method for generating a UI, according to embodiments of the present disclosure.

FIG. 6 is a flowchart of a method for handling user inputs in a UI, according to embodiments of the present disclosure.

FIG. 7 is a flowchart of a method for reacting to user edits to a transcript made in a UI, according to embodiments of the present disclosure.

FIG. 8 illustrates an example computing device, according to embodiments of the present disclosure.

### DETAILED DESCRIPTION

Because transcripts of spoken conversations are becoming increasingly important in a variety of fields, the accuracy of those transcripts and the interpreted elements extracted from those transcripts are also increasing in importance. Accordingly, accuracy in the transcript affects the accuracy in the later analyses, and greater accuracy in transcription and analysis improves the usefulness of the underlying systems used to generate the transcript and analyses thereof.

To create these transcripts and the analyses thereof, the present disclosure describes a Natural Language Processing (NLP) system. As used herein, NLP is the technical field for the interaction between computing devices and unstructured human language for the computing devices to be able to “understand” the contents of the conversation and react accordingly. An NLP system may be divided into a Speech Recognition (SR) system, that generates a transcript from a spoken conversation, and an analysis system, that extracts additional information from the written record. In various embodiments, the NLP system may use separate Machine Learning Models (MLMs) for each of the SR system and the analysis system, or may use one MLM with different layers for each of the SR system and the analysis system.

To improve the accuracy of the MLMs used in the NLP system, and improve the usefulness of the resultant transcript and analyses, the analysis system interfaces with an output device to provide a User Interface (UI) that allows for easy navigation within the transcript, and simplifies edits to the underlying MLMs. The disclosed UI links analyzed segments of transcripts to extracted key points from the conversation. In some embodiments, the UI may provide users with greater control over and more confidence in the MLMs used to generate the transcripts from natural language conversations. Accordingly, the UI discussed herein offers an improved User Experience (UX) to expose the operations of the MLMs and NLP systems underlying the transcription and interpretation processes to thereby improve the ability of the users to customize and update the MLMs and NLP systems to specific use domains and individual user preferences.

As the human users interact with a transcript and the extracted elements from the transcript via the UI, some or all of the operations of the MLM are exposed to the users. By exposing the operations of the MLMs, the UI provides the users with the opportunity to provide edits and more-relevant feedback to the outputs of the MLMs. Accordingly, the UI give the users a greater control over retraining or updating MLMs for specific use cases. This greater level of control, in turn, provides greater confidence in the accuracy of the MLMs and NLP systems, and thus can expand the functionalities for using the data output by the MLMs and NLP systems or reduce the need for a human user to confirm the outputs of the MLMs and NLP systems. However, in scenarios where the MLMs and NLP systems are still monitored by a human user, or the human user otherwise interacts with or edits the outputs of the MLMs and NLP systems, the UI provides a faster and more convenient way to perform those interactions and edits than previous UIs. Accordingly, the present disclosure is generally directed to increasing and improving the functionality, efficiency, and usability of the underlying computing systems and MLMs via the various methods and apparatuses described herein via an improved UI and UX.

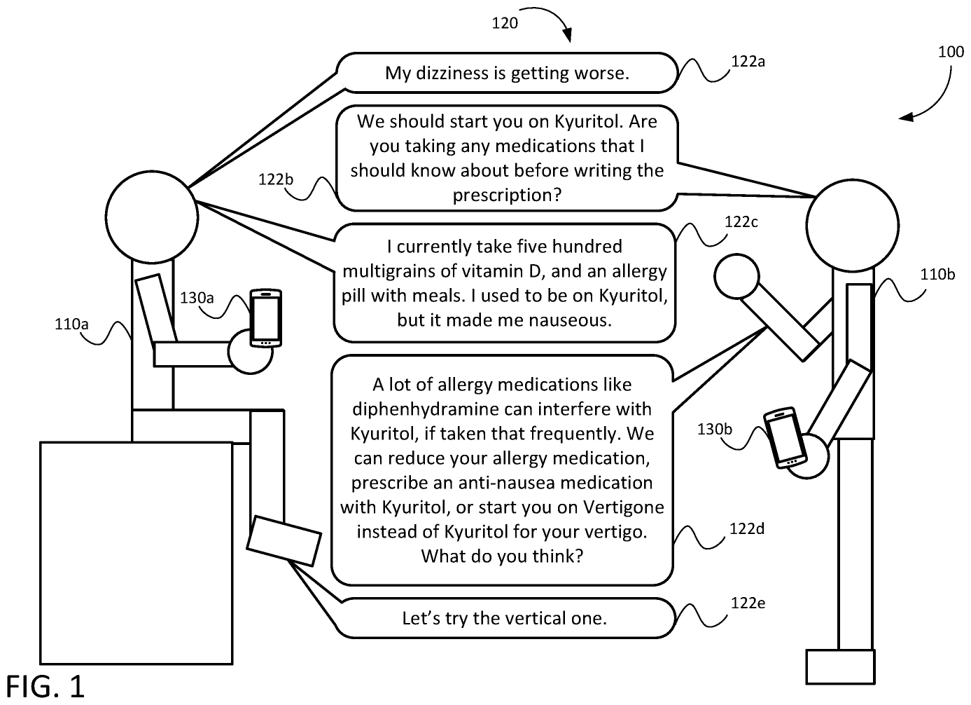

FIG. 1 illustrates an example environment 100 in which a conversation is taking place, according to embodiments of the present disclosure. As shown in FIG. 1, a first party 110a (generally or collectively, party 110) is holding a conversation 120 with a second party 110b. The conversation 120 is spoken aloud and includes several utterances 122a-e (generally or collectively, utterances 122) spoken by the first party 110a and by the second party 110b in relation to a healthcare visit. As shown in the example scenario, the first party 110a is a patient and the second party 110b is a caregiver (e.g., a doctor, nurse, nurse practitioner, physician's assistant, etc.). Although two parties 110 are shown in FIG. 1, in various embodiments, more than two parties 110 may contribute to the conversation 120 or may be present in the environment 100 and not contribute to the conversation 120 (e.g., by not providing utterances 122).

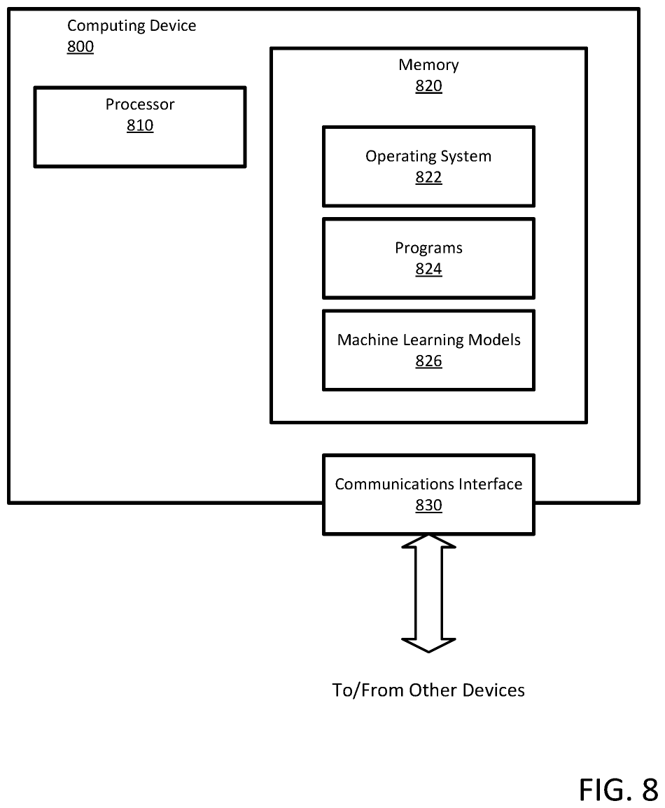

One or more recording devices 130a-b (generally or collectively, recording device 130) are included in the environment 100 to record the conversation 120. In various embodiments, the recording devices 130 may be any device (e.g., such as the computing device 800 described in relation to FIG. 8) that is capable of recording the audio of the conversation, which may include cellphones, dictation devices, laptops, tablets, personal assistant devices, or the like. In various embodiments, the recording devices 130 may transmit the conversation 120 for processing to a remote service (e.g., via a telephone or data network), locally store or cache the recording of the conversation 120 for later processing (locally or remotely), or combinations thereof. In various embodiments, the recording device 130 may pre-process the recording of the conversation 120 to remove or filter out environmental noise, compress the audio, remove undesired sections of the conversation (e.g., silences or user-indicated portions to remove), which may reduce data transmission loads or otherwise increase the speed of transmission of the conversation 120 over a network.

Although FIG. 1 shows two recording devices 130 in the environment 100, where each recording device 130 is associated with one party 110, the present disclosure contemplates other embodiments that may include more or fewer recording devices 130 with different associations to the various parties 110 in the environment 100. For example, a recording device 130 may be associated with the environment 100 (e.g., a recording device 130 for a given room) instead of a party 110, or may be associated with parties 110 who are not participating in the conversation 120, but are present in the environment 100. Additionally, although the environment 100 is shown as a room in which both parties 110 are co-located, in various embodiments, the environment 100 may be a virtual environment or two distant spaces that at linked via teleconference software, a telephone call, or other situation where the parties 110 are not co-located, but are linked technologically to hold the conversation 120.

Recording and transcribing conversations 120 related to healthcare, technology, academia, or various other esoteric topics can be particularly challenging for NLP systems due to the low number of example utterances 122 that include related terms, the inclusion of jargon and shorthand used in the particular domain, the similarities in phonetics of markedly different terms within the domain (e.g., lactase vs. lactose), similar terms having certain meanings inside of the domain that are different from or more specific than the meanings used outside of the domain, mispronunciation or misuse of domain terms by non-experts speaking to domain experts, and other challenges.

One such challenge is that different parties 110 to the conversation 120 may have different levels of experience in the use of the terms used in the conversation 120 or the pronunciation of those terms. For example, an experienced mechanic may refer to a component of an engine by part number, by a nickname, or the specific technical term, while an inexperienced mechanic (or the owner) may refer to the same component via a placeholder (e.g., “the part”), an incorrect term, or an unusual pronunciation (e.g., placing emphasis on the wrong syllable). In another example, a teacher may record a conversation with student, where the teacher corrects the student's use of various terms or pronunciation, and the conversation 120 includes the misused terminologies, despite both the student and teacher attempting to refer to the same concept. Distinguishing which party 110 is “correct” and that both parties 110 are attempting to refer to the same concept within the domain despite using different wording or pronunciation, can therefore prove challenging for NLP systems.

As illustrated, the conversation 120 includes an exchange between a patient and a caregiver related to the medications that the patient should be prescribed to treat an underlying condition as one example of an esoteric conversation 120 occurring in a healthcare setting. FIG. 1 illustrates the conversation 120 using the intended contents of the utterances 122 from the perspectives of the speakers of those utterances 122, which may include errors made by the speaker. The examples given elsewhere in the present disclosure may build upon the example given in FIG. 1 to variously include misidentified versions of the contents or corrected versions of the contents.

For example, when an NLP system erroneously identifies spoken term_{A} (e.g., the NLP system identified an utterance of be “taste taker”), a user or correction program, may correct the transcription to instead display term_{B} (e.g., changing “taste taker” to “pacemaker” as intended in the utterance). In another example, when a party 110 intended to say term_{A}, and was identified as saying term_{A}, but the correct term is term_{B}, the NLP system can substitutes term_{B} for term_{A} in the transcript.

What term is “correct” may vary based on the level of experience of the party, so that the NLP system may substitute synonymous terms as being more “correct” for the user's context. For example, when a doctor states correctly the chemical name for the allergy medication “diphenhydramine”, the NLP system can “correct” the transcript to read or include additional definitions to state “your allergy medication”. Similarly, various jargon or shorthand phrases may be removed for the more-accessible versions of those phrases in the transcript. Additionally or alternatively, if the party 110 is identified as attempting to say (and mispronouncing) a difficult to pronounce term, such as a chemical name for the allergy medication “diphenhydramine”, (e.g., as “DIFF-enhy-DRAY-MINE” rather than “di-FEN-hye-DRA-meen”), the NLP system can correct the transcript to remove any misidentified terms based on the mispronounced term and substitute in the correct difficult-to-pronounce term.

As intended by the participants of the example conversation 120, the first utterance 122a from the patient includes spoken contents of “my dizziness is getting worse”, to which the caregiver replies in the second utterance 122b “We should start you on Kyuritol. Are you taking any medications that I should know about before writing the prescription?”. The patient replies in the third utterance 122c that “I currently take five hundred multigrains of vitamin D, and an allergy pill with meals. I used to be on Kyuritol, but it made me nauseous.” The caregiver responds in the fourth utterance 122d with “a lot of allergy medications like diphenhydramine can interfere with Kyuritol, if taken that frequently. We can reduce your allergy medication, prescribe an anti-nausea medication with Kyuritol, or start you on Vertigone instead of Kyuritol for your vertigo. What do you think?”. The conversation 120 concludes with the fifth utterance 122e from the patient of “let's try the vertical one.”

Using the illustrated conversation 120 as an example, the patient provided several utterances 122 with misspoken terminology (e.g., “multigrains” instead of “milligrams”, “vertical” instead of “Vertigone” or “vertigo”) that the caregiver did not follow up on (e.g., no question requesting clarification was spoken), as the intended meaning of the utterances 122 was likely clear in context to the caregiver. However, the NLP system may accurately transcribe these misstatements, which can lead to confusion or misidentification of the features of the conversation 120 by a MLM or human user that later reviews the transcript. When later reviewing the transcript, the context may have to be reestablished before the intended meaning of the misspoken utterances can be made clear, thus causing human frustration or errors in analysis systems unless additional time to read and analyze the transcript is expended.

Additionally or alternatively, the inclusion of terms unfamiliar to a party 110 in the conversation 120, even if provided accurately in a later transcript, may lead to confusion or misidentification of the conversation 120 by a MLM or human user. For example, the caregiver mentioned “diphenhydramine”, which may be an unfamiliar term to the patient, despite referring to a popular antihistamine and allergy medication, and the caregiver uses the more scientific-sounding term “vertigo” to refer to condition indicated by the symptom of “dizziness” spoken by the patient, which may have been clear in context at the time of the conversation 120 or glossed over during the conversation 120, but are deserving of follow-up when reviewing the transcript.

The present disclosure therefore provides for UIs that allow users to be able to easily interact with the transcripts to expose various processes of the NLP systems and MLMs that produced and interacted with the conversation 120 and transcripts thereof. A user is thereby provided with an improved experience in examining the transcript and modifying the underlying NLP systems and MLMs to provide more accurate and better trusted analysis results in the future.

Although the present disclosure primarily uses the example conversation related to a healthcare visit shown in FIG. 1 as a basis for the examples discussed in the other Figures, the present disclosure may be used for the provision and manipulation of interactive data gleaned from transcripts of conversations related to various topics outside of the healthcare space or between different parties within the healthcare space. Accordingly, the environment 100 and conversation 120 shown and discussed in relation to FIG. 1 are provided as a non-limiting example; other conversations in other settings (e.g., equipment maintenance, education, law, agriculture, etc.) and between other persons (e.g., a first caregiver and a second caregiver, a guardian and a caregiver, a guardian and a patient, etc.) are contemplated by the present disclosure.

Additionally, although the example conversations and analyzed terms discussed herein are primarily provided in English, the present disclosure may be applied for transcribing a variety of languages with different vocabularies, grammatical rules, word-formation rules, and use of tone to convey complex semantic meanings and relationships between words.

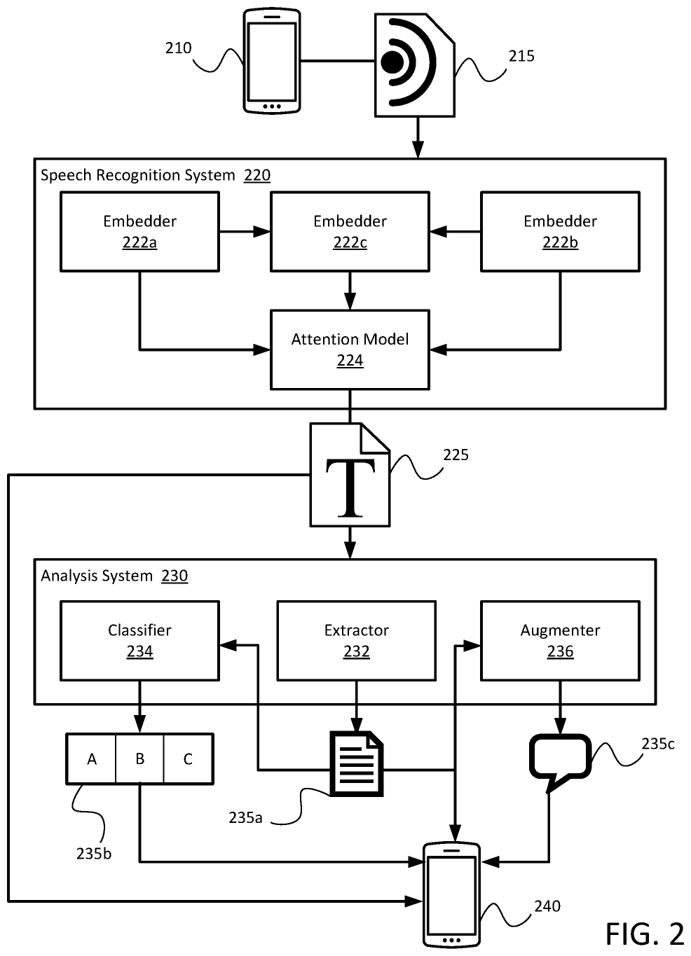

FIG. 2 illustrates a computing environment 200, according to embodiments of the present disclosure. The computing environment 200 may represent a distributed computing environment that includes multiple computers, such as the computing device 800 discussed in relation to FIG. 8, interacting to provide different elements of the computing environment 200 or may include a single computer that locally provides the different elements of the computing environment 200. Accordingly, some or all of the elements illustrated with a single reference number or object in FIG. 2 may include several instances of that element, and individual elements illustrated with one reference number or object may be performed partially or in parallel by multiple computing devices.

The computing environment 200 includes an audio provider 210, such as a recording device 130 described in relation to FIG. 1, that provides a recording 215 of a completed conversation or individual utterances of an ongoing conversation to a Speech Recognition (SR) system 220 to identify the various words and intents within the conversation. The SR system 220 provides a transcript 225 of the recording 215 to an analysis system 230 to identify and analyze various aspects of the conversation relevant to the participants. As used herein, the SR system 220 and the analysis system 230 may be jointly referred to as an NLP system.

As received, the recording 215 may include an audio file of the conversation, video data associated with the audio data (e.g., a video recording of the conversation vs. an audio-only recording), as well as various metadata related to the conversation, and may also include video data. For example, a user account associated with the audio provider 210 may serve to identify one or more of the participants in the conversation, or append metadata related to the participants. For example, when a recording 215 is received from an audio provider 210 associated with John Doe, the recording 215 may include metadata that John Doe is a participant in the conversation. The user of the audio provider 210 may also indicate that the conversation took place with Erika Mustermann, (e.g., to provide the identity of another speaker not associated with the audio provider 210), when the conversation took place, whether the conversation is complete or is ongoing, where the conversation took place, what the conversation concerns, or the like.

The SR system 220 receives the recording 215 and processes the recording 215 via various machine learning models to convert the spoken conversation into various words in textual form. The models may be domain specific (e.g., trained on a corpus of words for a particular technical field) or general purpose (e.g., trained on a corpus of words for general speech patterns). In various embodiments, the SR system 220 may use an Embedding from Language Models (ELMo) model or a Bidirectional Encoder Representation from Transformers (BERT) model or other machine learning models to convert the natural language spoken audio into a transcribed version of the audio. In various embodiments, the SR system 220 may use Transformer networks, a Connectionist Temporal Classification (CTC) phoneme based model, a Listen Attend and Spell (LAS) grapheme based model, or any of other models to convert the natural language spoken audio into a transcribed version of the audio. In some embodiments, the analysis system 230 may be a large language model.

Converting the spoken utterances to a written transcript not only matches the phonemes to corresponding characters and words, but also uses the syntactical and grammatical relationship between the words to identify a semantic intent of the utterance. The SR system 220 uses this identified semantic intent to select the most correct word in the context of the conversation. For example, the words “there”, “their”, and “they're” all sound identical in most English dialects and accents, but convey different semantic intents, and the SR system 220 selects one of the options for inclusion in the transcript for a given utterance. Accordingly, an attention model 224, is used to provide context of the various different candidate words among each other. The selected attention model 224 can use a Long Short Term Memory (LSTM) architecture or transformers to track relevancy of nearby words on the syntactical and grammatical relationships between words at a sentence level or across sentences (e.g., to identify a noun introduced in an earlier utterance related to a pronoun in a later utterance).

The SR system 220 can include one or more embedders 222a-c (generally or collectively embedder 222) to embed further annotations to the transcript 225, such as, for example by including: key term identifiers, timestamps, segment boundaries, speaker identifies, and the like. Each embedder 222 may be a trained MLM to identify various features in the audio recording 215 and/or transcript 225 that are used for further analysis by an attention model 224 or extraction by the analysis system 230.

For example, a first embedder 222a is trained to recognize key terms, and may be provided with a set of words, relations between words, or the like to analyze the transcript 225 for. Key terms may be defined to include various terms (and synonyms) of interest to the users. For example, in a medical domain, the names of various medications, therapies, regimens, syndromes, diseases, symptoms, etc., can be set as key terms. In a maintenance domain, the names of various mechanical or electrical components, assurance tests, completed systems, locational terms, procedures, etc., can be set as key terms. In another example, time based words may be identified as candidate key terms (e.g., Friday, tomorrow, last week). Once recognized in the text of the transcript, a key term embedder 222 may embed a metadata tag to identify the related word or set of words as a key term, which may include tagging pronouns associated with a noun with the same metadata tags as the associated noun.

A second embedder 222b can be used by the SR system 220 to recognize different participants in the conversation. In various embodiments, individual speakers may be distinguished by vocal patterns (e.g., a different fundamental frequency for each speaker's voice), loudness of the utterances (e.g., identifying different locations relative to a recording device), or the like.

In another example, a third embedder 222c is trained to recognize segments within a conversation. In various embodiments, the SR system 220 diarizes the conversation into portions that identify the speaker, and provides punctuation for the resulting sentences (e.g., commas at short pauses, periods at longer pauses, question marks at a longer pause preceded by rising intonation) based on the language being spoken. The third embedder 222c may then add metadata tags for who is speaking a given sentence (as determined by the second embedder 222b) and group one or more portions of the sentence together into segments based on one or more of a shared theme or shared speaker, question breaks in the conversation, time period (e.g., a segment may be between X and Y minutes long before being joined with another segment or broken into multiple segments), or the like.

When using a shared theme to generate segments, the SR system 220 may use some of the key terms identified by a key term embedder 222 via string matching. For each of the detected key terms identifying a theme, the segment identifying embedder 222 selects a set of nearby sentences to group together as a segment. For example, when a first sentence uses a noun, and a second sentence uses a pronoun for that noun, the two sentences may be grouped together as a sentence. In another example, when a first person provides a question, and a second person provides a responsive answer to that question, the question and the answer may be grouped together as a segment. In some embodiments, the SR system 220 may define a segment to include between X and Y sentences, where another key term for another segment (and the proximity to the second key term to the first) may define ab edge between adjacent segments.

Once the SR system 220 generates a transcript 225 of the identified words from the recording 215, the SR system 220 provides the transcript 225 to an analysis system 230 to generate various analysis outputs 235 from the conversation. In various embodiments, the operations of the SR system 220 are separately controlled from the operations of the analysis system 230, and the analysis system 230 may therefore operate on a transcript 225 of a written conversation or a human-generated transcript (e.g., omitting the SR system 220 from the NLP system or substituting a non-MLM system for the SR system 220). The SR system 220 may directly transmit the transcript 225 to the output device 240 (before or after the analysis system 230 has analyzed the transcript 225), or the analysis system 230 may transmit the transcript 225 to the output device 240 on behalf of the SR system 220 once analysis is complete.

The analysis system 230 may use an extractor 232 to generate readouts 235a of the key points to provide human-readable summaries of the interactions between the various identified key terms from the transcript. These summaries include the identified key terms (or related synonyms) and are formatted according to factors for sufficiency, minimality, and naturalness. Sufficiency defines a characteristic for a key point that, if given only the annotated span, a reader should be able to predict the correct classification label for the key point, which encourages longer key points that cover all distinguishing or background information needed to interpret the contents of a key point. Minimality defines a characteristic for a key point that identifies peripheral words which can be replaced with other words without changing the classification label for the key point, which discourages marking entire utterances as needed for the interpretation of a key point. Naturalness defines a characteristic for a key point that, if presented to a human reader should sound like a complete phrases in the language used (or as a meaningful word if the key point has only a single key term) to avoid dropping stop words from within phrases and reduce the cognitive load on the human who uses the NLP system's extraction output.

For example, when presented with a series of sentences from the transcript 225 related to how frequently a user should replace a battery in a device, and what type of battery to use, the extractor 232 may analyze several sentences or segments to identify relevant utterances spoken by more than one person to arrive at a summary. The readout 235a may recite “Replace battery; Every year; Use nine volt alkaline” to provide all or most of the relevant information in a human-readable format that was gathered from a much larger conversation.

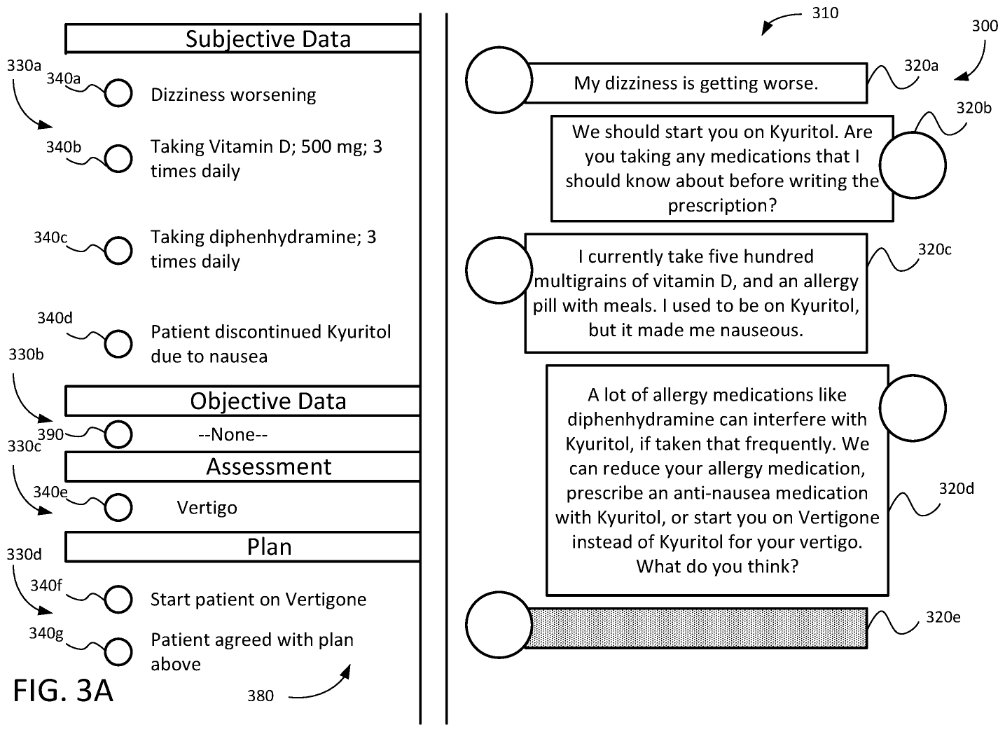

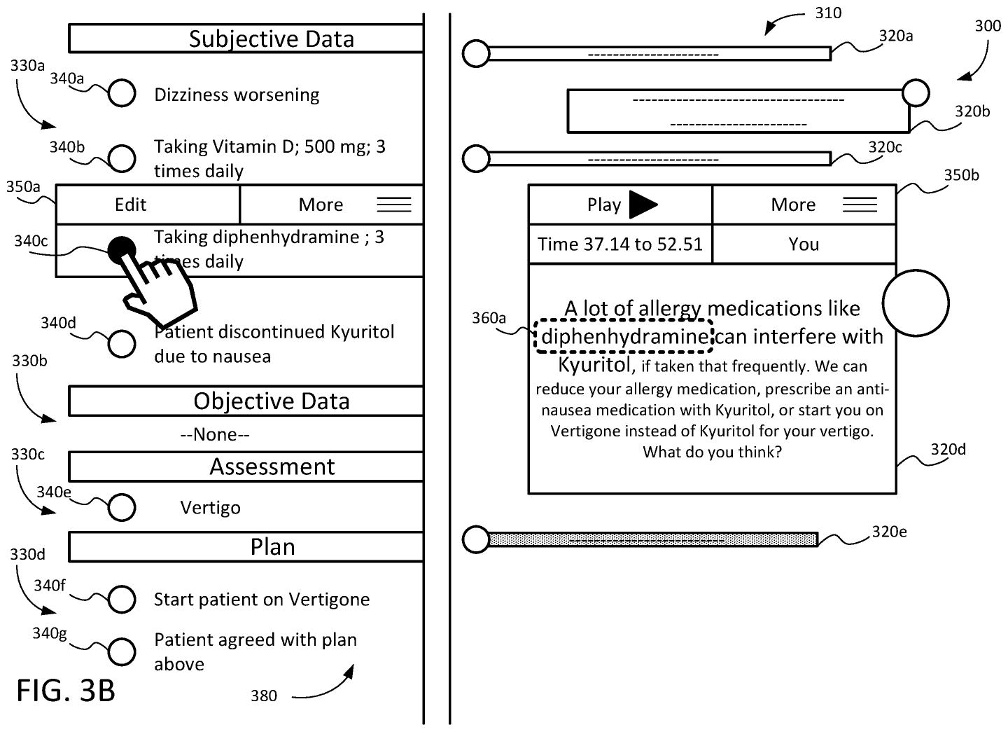

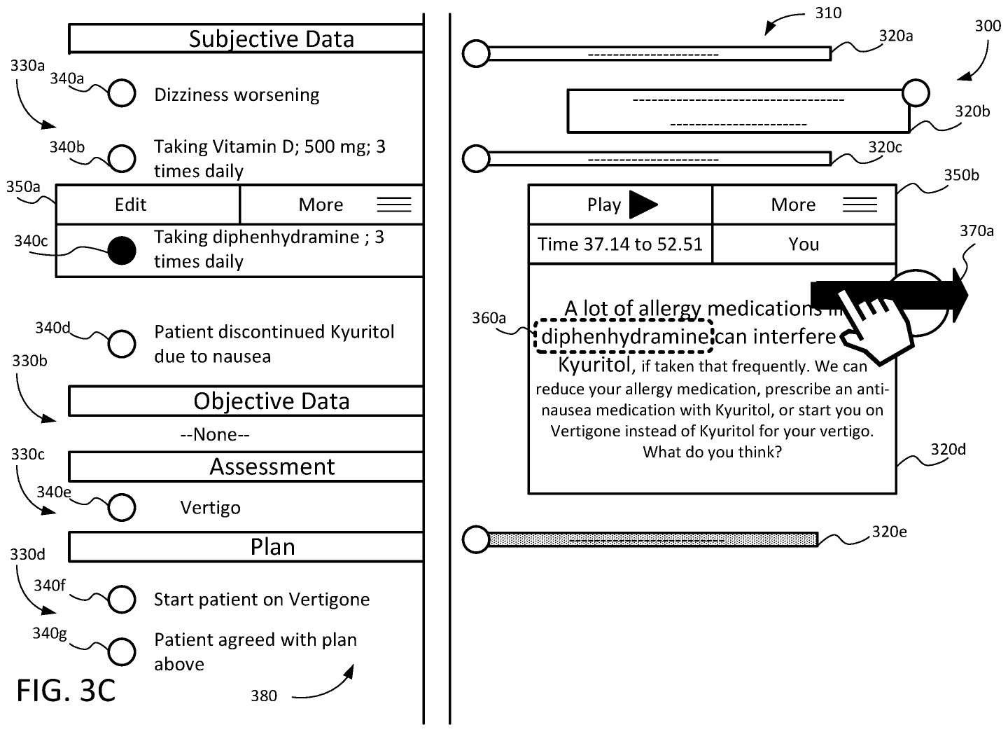

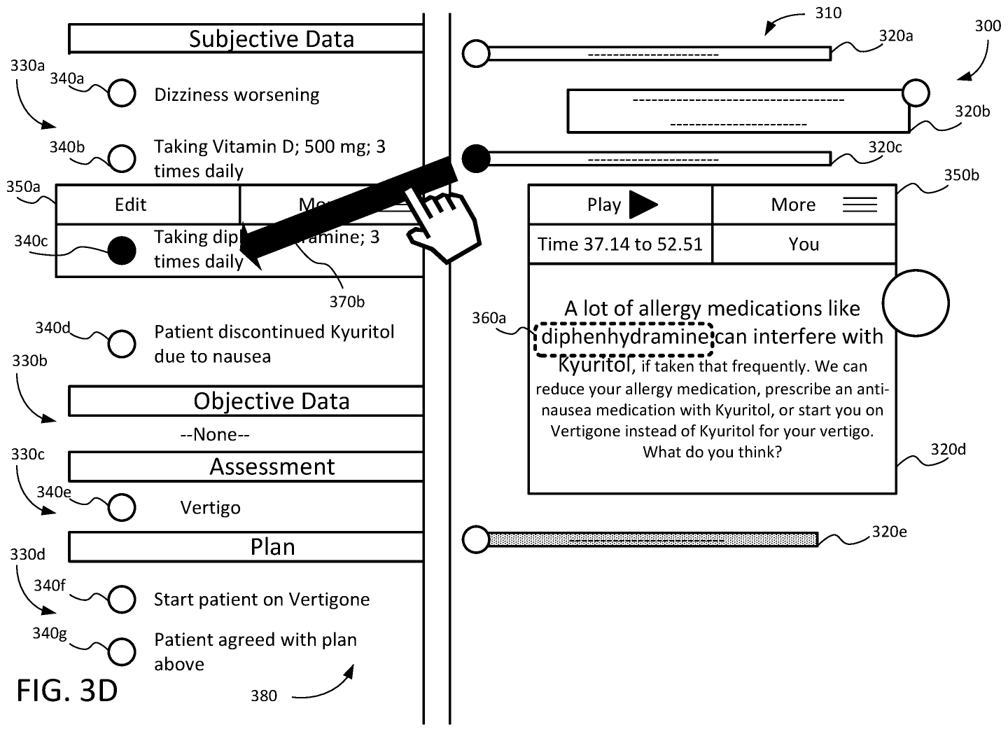

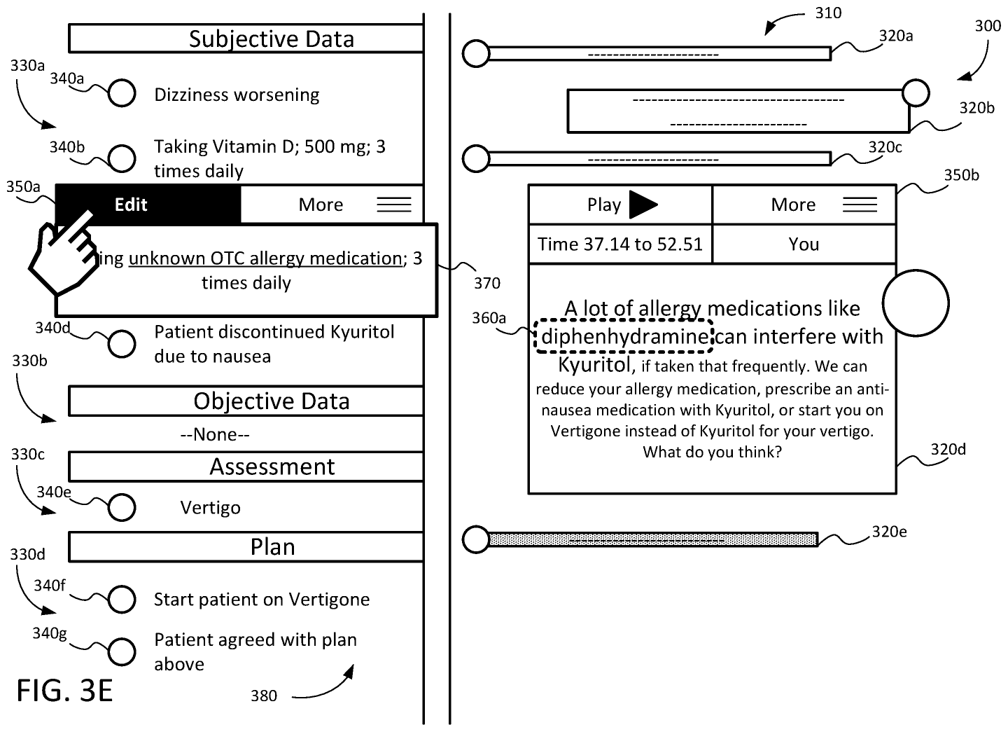

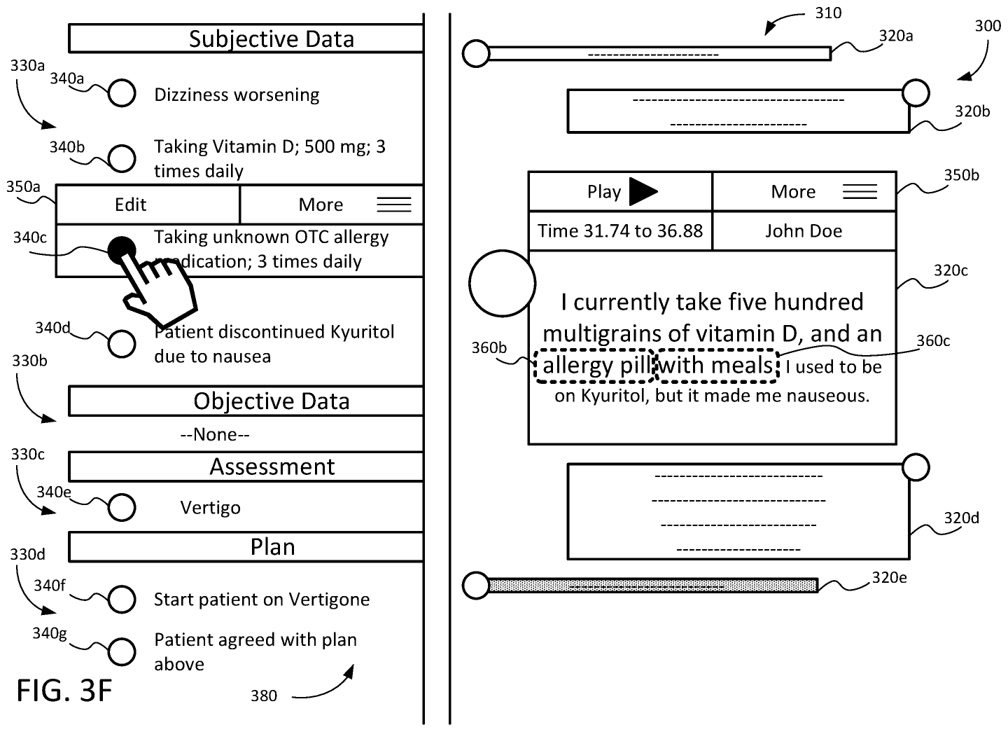

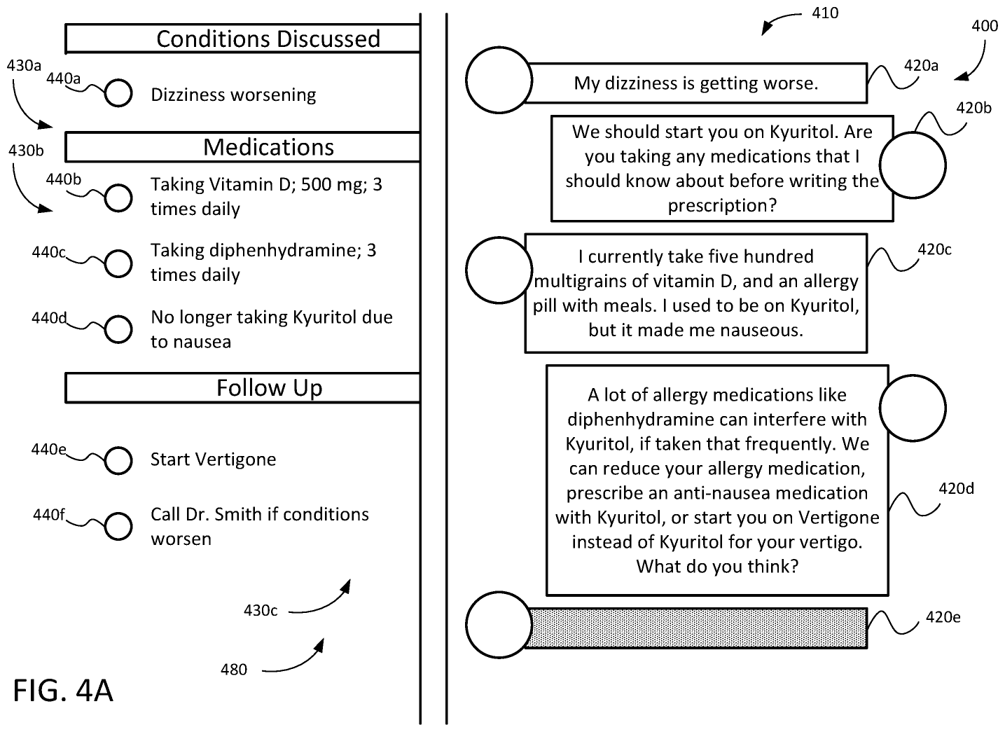

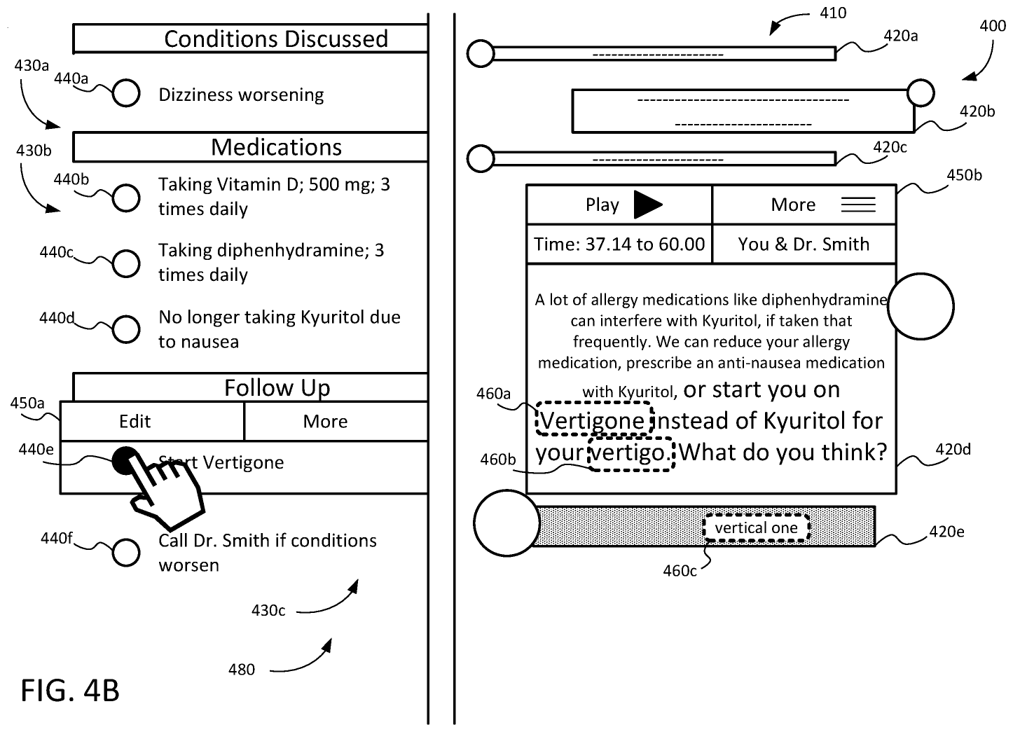

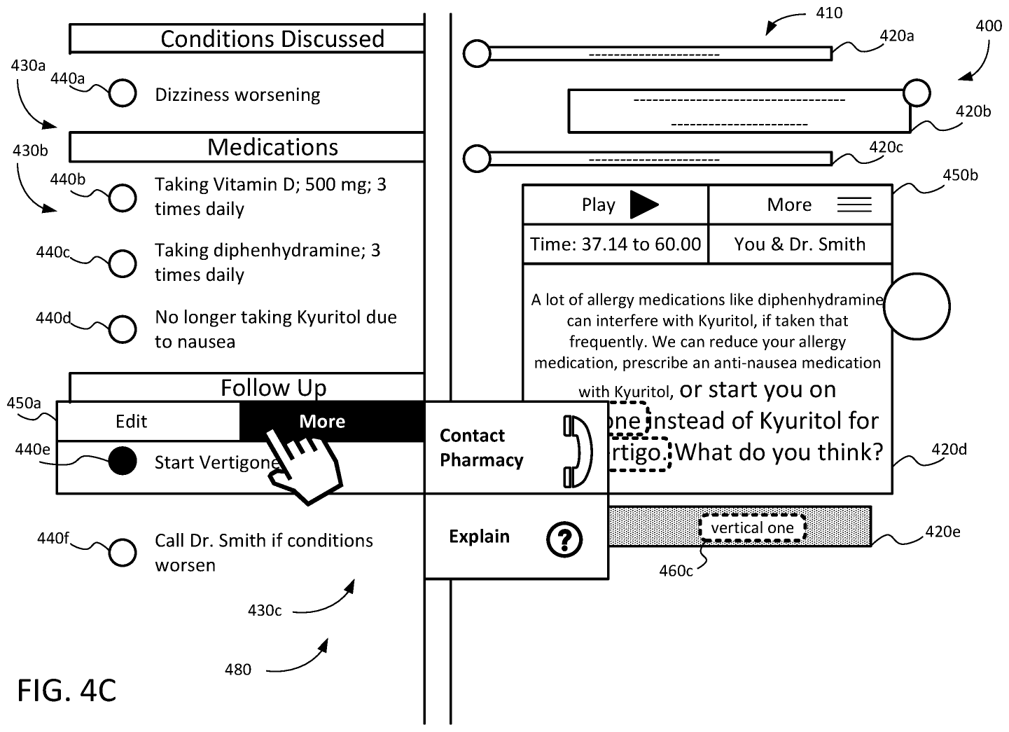

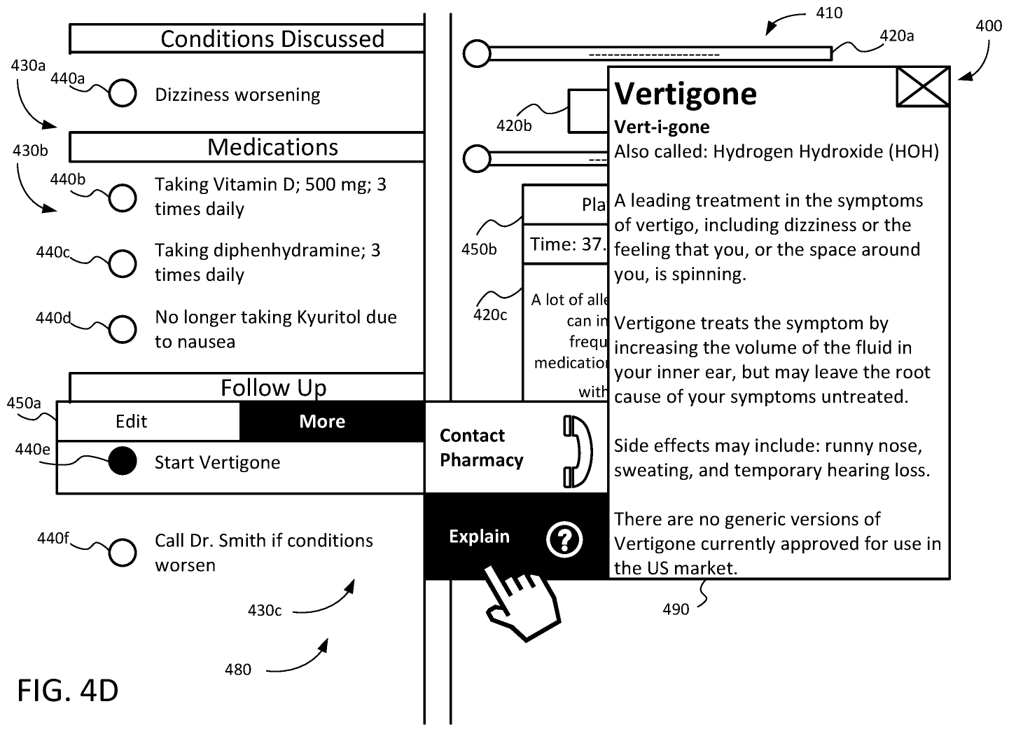

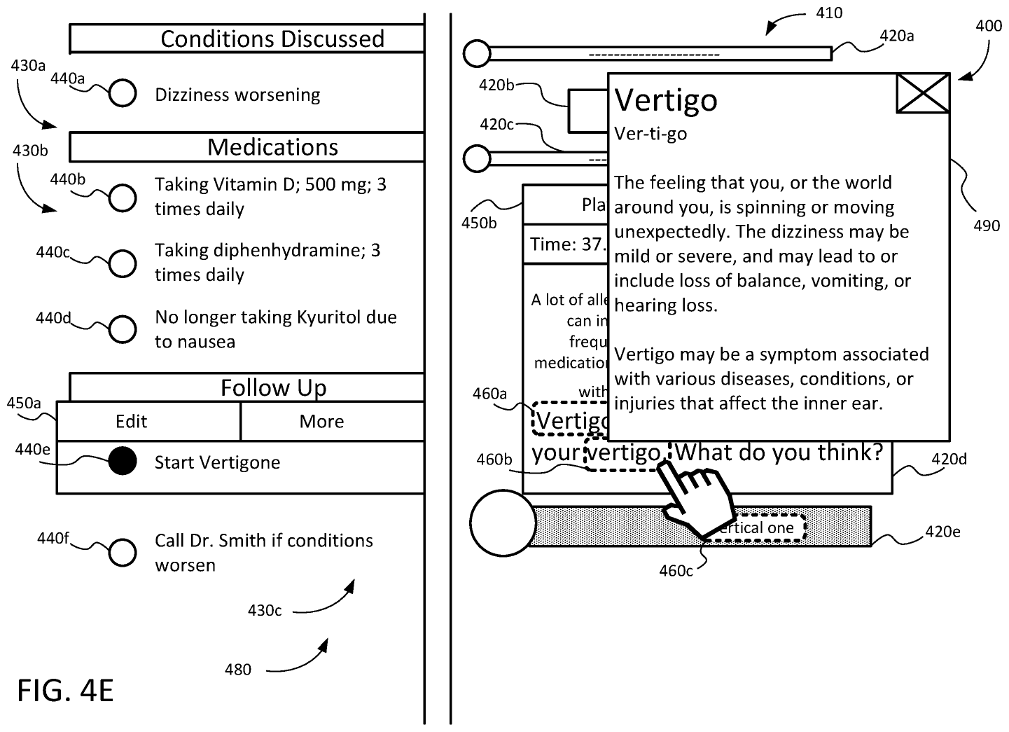

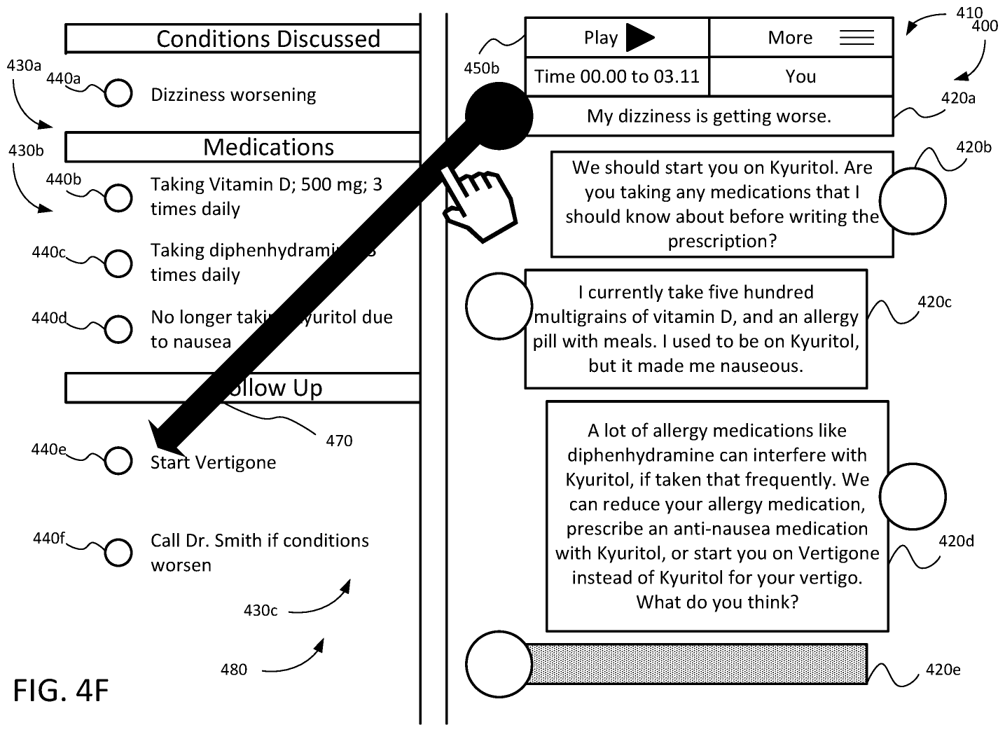

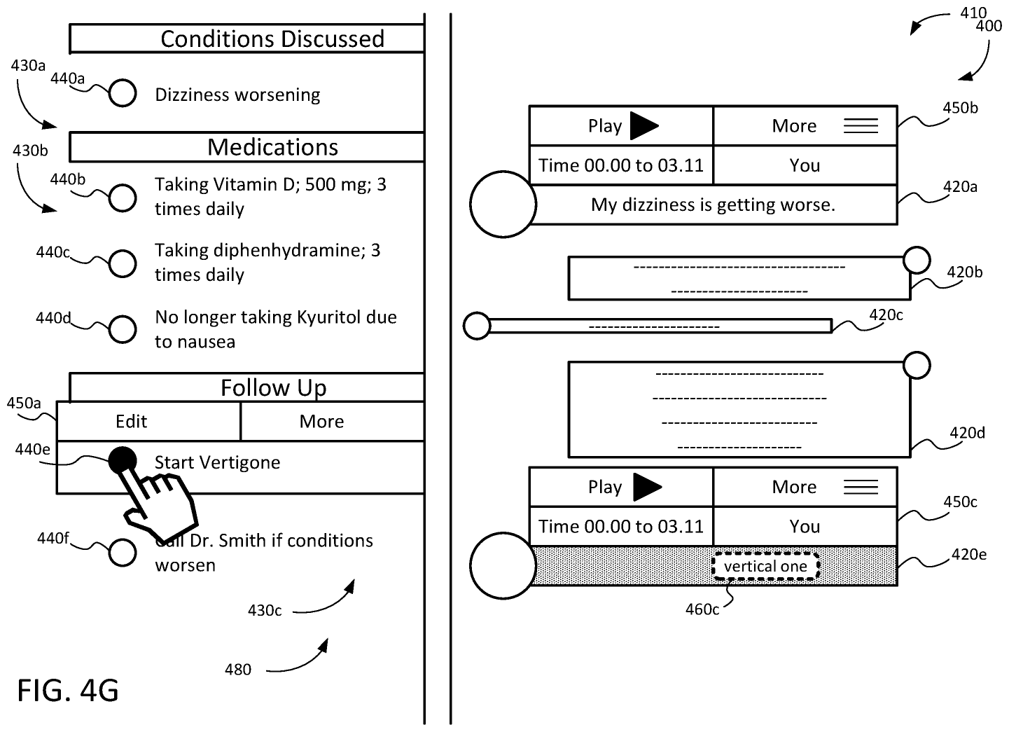

A category classifier 234 included in the analysis system 230 may operate in conjunction with the extractor 232 to identify various categories 235b that the readouts 235a belong to. In various embodiments, the categories 235b include several different classifications for different users with different review goals for the same conversation. Examples of different classifications for the same conversation are given in relation to FIGS. 3A-3F and 4A-4G. In various embodiments, the category classifier 234 determines the classification based on one or more context vectors developed via the attention model 224 of the SR system 220 to identify whether a given segment or portion of the conversation belongs to which category (including a null category) out of a plurality of potential categories that a user can select from the system to classify portions of the conversation into.

The analysis system 230 may include an augmenter 236 that operates in conjunction with the extractor 232 to develop supplemental content 235c to provide with the transcript 225. In various embodiments, the supplemental content 235c can include callouts of pseudo-key terms based on inferred or omitted details from a conversation, hyperlinks between key points and semantically relevant segments of the transcript, links to (or provides the content for) supplemental or definitional information to display with the transcript, calendar integration with extracted terms, or the like.

For example, when the extractor 232 identifies terms related to a planned follow up conversation (e.g., “I will call you back in thirty minutes”), the augmenter 236 can generate supplemental content 235c that includes a calendar invitation or reminder in a calendar application associated with one or more of the participants that a call is expected thirty minutes from when the conversation took place. Similarly, if the augmenter 236 identifies terms related to a planned follow up conversation that omits temporal information (e.g., “I will call you back”), the augmenter 236 can generate a pseudo-key term to treat the open-ended follow up as though an actual follow up time had been set (e.g., to follow up within a day or set a reminder to provide a more definite follow up time within a system-defined placeholder amount of time).

In various embodiments, when generating supplemental content 235c of a hyperlink between an extracted key point and a segment from the transcript, the augmenter 236 links the most-semantically-relevant segment with the key point, to allow users to navigate to relevant portions of the transcript 225 via the key points. As used herein, the most-semantically-relevant segment refers to the one segment that provides the greatest effect on the category classifier 234 choosing to select one category for the key point, or the one segment that provides the greatest effect on the extractor 232 to identify the key point within the context of the conversation. Stated differently, the most-semantically-relevant segment is the portion of the conversation that has the greatest effect on how the analysis system 230 interprets the meaning and importance of the key point within the conversation.

Additionally, the augmenter 236 may generate or provide supplemental content 235c for defining or explaining various key terms to a reader. For example, links to third-party webpages to explain or provide pictures of various unfamiliar terms, or details recalled from a repository associated with a key term dictionary, can be provided by the augmenter 236 as supplemental content 235c.

The augmenter 236 may format the hyperlink to include the primary target of the linkage (e.g., the most-semantically-relevant segment), various secondary targets to use in updating the linkage based on user feedback (e.g., a next-most-semantically-relevant segment), and various additional effects or content to call based on the formatting guidelines of various programming or markup languages.

Each of the extractor 232, category classifier 234, and the augmenter 236 may be separate MLMs or different layers within one MLM provided by the analysis system 230. Similarly, although illustrated in FIG. 2 with separate modules for an extractor 232, classifier 234, and augmenter 236, in various embodiments, the analysis system 230 may omit one or more of the extractor 232, classifier 234, and augmenter 236 or combine two or more of the extractor 232, classifier 234, and augmenter 236 in a single module. Additionally, the flow of outputs and inputs between the various modules of the analysis system 230 may differ from what is shown in FIG. 2 according to the design of the analysis system 230. When training the one or more MLMs of the analysis system 230, the MLMs may be trained via a first inaccurate supervision technique, such as via fine tuning a large language model, and subsequently by a second incomplete supervision technique to fine-tune the inaccurate supervision technique and thereby avoid catastrophic forgetting. Additional feedback from the user may be used to provide supervised examples for further training of the MLMs and better weighting of the factors used to identify relevancy of various segments of a conversation to the key points therein, and how those key points are to be categorized for review.

The analysis system 230 provides the analysis outputs 235 to an output device 240 for storage or output to a user. In some embodiments, the output device 240 may be the same or a different device from the audio provider 210. For example, a caregiver may record a conversation via a cellphone as the audio provider 210, and receive and interact with the transcript 225 and analysis outputs 235 of the conversation via the cellphone. In another example, the caregiver may record a conversation via a cellphone as the audio provider 210, and receive and interact with the transcript 225 and analysis outputs 235 of the conversation via a laptop computer.

In various embodiments, the output device 240 is part of a cloud storage or networked device that stores the transcript 225 and analysis outputs 235 for access by other devices that supply matching credentials to allow for access on multiple endpoints.

FIGS. 3A-3F illustrate interactions with a UI 300 that displays a transcript and analysis outputs from a conversation (such as, but not limited to, the conversation 120 discussed in relation to FIG. 1) for a first user type, according to embodiments of the present disclosure. Using the example conversation 120 from FIG. 1, the UI 300 illustrated in FIGS. 3A-3F shows a perspective for a caregiver-adapted interface, whereas the UI 400 illustrated in FIGS. 4A-4G shows a perspective for a patient-adapted interface. In various embodiments, other conversations may relate to different conversational domains taken from different perspectives than those illustrated in the current example.

FIG. 3A illustrates a first state of the UI 300, as may be provided to a user after initial analysis of an audio recording of a conversation by an NLP system. The transcript is shown in a transcript window 310, which includes several segments 320a-320e (generally or collectively, segment 320) identified within the conversation. In various embodiments, the segments 320 may represent speaker turns in the conversation, sentences identified in the conversation, topics identified in the conversation, a given length of time in the conversation (e.g., every X seconds), combinations thereof, and other divisions of the conversation.

Each segment 320 includes a portion of the written text of the transcript, and provides a UI element that allows the user to access the corresponding audio recording, make edits to the transcript, zoom in on the text, and otherwise receive additional detail for the selected portion of the conversation. Although the transcript illustrated in FIGS. 3A-3F includes the entire conversation 120 given as an example in FIG. 1, in various embodiments, the UI 300 may omit portions of the transcript from initial display. For example, the UI 300 may initially display only the segments 320 from which key terms have been identified or key points have been extracted (e.g., to skip introductory remarks or provide a summary), with the non-displayed segments 320 being omitted from display (e.g., positioned “off screen” for later access), shown as thumbnails, etc.

In various embodiments, additional data or metadata related to the segment 320 (e.g., speaker, topic, confidence in written text accurately matching input audio, whether edited by a user) can be presented based on color or shading of the segment 320 or alignment of the segment 320 in the transcript window 310. For example, the first segment 320a, the third segment 320c, and the fifth segment 320e are shown as left-aligned versus the second segment 320b and the fourth segment 320d, which are shown as right-aligned, which indicates different speakers for the differently aligned segments 320. In another example, the fifth segment 320e is displayed with a different shading than the other segments 320, which may indicate that the NLP system is confident that human error is present in the fifth segment 320e, that the NLP system is not confident in the transcribed words matching the spoken utterance, or another aspect of the fifth segment 320e that deserves additional attention from the user.

Depending on the display area available in which to present the UI 300, the transcript window 310 may include some or all of the segments 320 at a given time. Accordingly, although not illustrated, in various embodiments, the transcript window 310 may include various content controls (e.g., scroll bars, text size controls, etc.) to enable access to more content than can be legibly displayed at one time on the device outputting the UI 300. For example, content controls can allow a user to scroll to currently off-screen elements, zoom in on elements below a size threshold or presented as thumbnails when not selected, or the like.

Outside of the transcript window 310, the UI 300 displays categorized analysis outputs in an analysis window 380 in one or more categories 330a-d (generally or collectively, category 330). The categories include various selectable representations 340a-g (generally or collectively, representations 340) of key points extracted from the conversation. For example, under a first category 330a of “subjective data”, the UI 300 includes four representations 340a-d for key points classified as related to “subjective data” extracted from the conversation. Other key points extracted from the conversation are classified into other categories 330, such that the key point for “vertigo” which is classified under the third category 330c for “assessments”, and the key points for “starting Vertigone” and whether the patient agreed with the plan under the fourth category 330d for the “plan”.

Although the UI 300 illustrated in FIGS. 3A-3F displays four categories 330 corresponding to the SOAP (Subjective, Objective, Assessment, Plan) note structure used by many physicians, the analysis window 380 may display more than, fewer than, and different arrangements of the categories 330 shown in FIGS. 3A-3F. Accordingly, for the same conversation, the UI 300 may show different orders and types of the representations 340 based on which categorization scheme is selected by the user.

In various embodiments, when no key points for a given classification are extracted from the conversation, the category 330 may display a null indicator 390. For example, the second category 330b of “objective data” includes a null indicator 390, which serves as an indication to the user that no related key points for “objective data” were extracted from the related conversation, despite analyzing the conversation for such key points. Additionally, the null indicator 390 serves as a UI element for drag and drop operations or selection within the UI 300 for editing the classification of various key points and portions of the transcript.

FIG. 3B illustrates selection of the third representation 340c in the UI 300. When a user, via input from one or more of a keyboard, pointing device, or touch screen, selects a representation 340, the UI 300 may update the display to include various contextual controls 350a-b or highlight related elements in the UI 300 to the selected element. For example, when selecting the third representation 340c, the UI 300 updates to include first contextual controls 350a in association with the third representation 340c to allow editing or further interaction with the underlying key point and analysis thereof.

Additionally, the UI 300 adjusts the display of the transcript to highlight the most-semantically-relevant segment 320 to the selected representation 340 for a key point. When highlighting the most-semantically-relevant segment 320, the UI 300 may increase the relative size of the most-semantically-relevant segment 320 to the other segments, as shown in FIG. 3B, but may also change the color, apply an animation effect, scroll which segments 320 are displayed (and where) within the transcript window 310, and combinations thereof to highlight the most-semantically-relevant segment 320 to the selected representation 340. In various embodiments, each representation 340 includes a hyperlink to the corresponding most-semantically-relevant segment 320 that includes the location of the most-semantically-relevant segment 320 within the transcript and any effects (e.g., color, animation, resizing, etc.) to apply to the corresponding segment 320 to highlight it as the most-semantically-relevant segment 320 for the selected representation 340.

Although shown with one segment 320 (the fourth segment 320d) being highlighted in response to receiving a selection of the third representation 340c, in various embodiments, one representation 340 may highlight two or more segments 320 when selected if relevancy carries across segments 320. Additionally, multiple representations 340 may indicate a shared (e.g., the same) segment 320 as the respective most-semantically-relevant segment 320. Accordingly, when a user selects different representations 340 associated with a shared segment 320, the UI 300 may apply a different animation effect or new color to the most-semantically-relevant segment 320 to indicate that the later selection resulted in re-highlighting the same segment 320.

As illustrated, the UI 300 adds second contextual controls 350b in association with the fourth segment 320d to provide additional information about the highlighted segment 320 to the user, and provide controls for the user to further interact with or edit the associated portion of the transcript. For example, a “play” button may provide a matched audio segment from the recorded section when selected by a user (e.g., starting playback at a timestamp correlated to the first word in the segment 320 and ending playback at a timestamp correlated to the last word in the segment 320), while a “more” button provides additional contextual controls 350 to the user when selected. Further details related to the conversation, the speaker, the topics discussed in the segment, timestamps for the segment 320, topics related in previous or subsequent segments, or the like may also be presented in the contextual controls 350 in various embodiments.

When a segment 320 is highlighted, the UI 300 may display various designators 360a-c (generally or collectively, designator 360) for words or phrases found in the highlighted segment 320 that have been identified as key terms related to the key point of the selected representation 340. For example, the selected third representation 340c represents a key point identified from the transcript related to “taking diphenhydramine three times daily”, and the information extracted from the transcript includes the utterance for “diphenhydramine” shown in the fourth segment 320d. Accordingly, the word “diphenhydramine” shown in the fourth segment 320d is displayed with a first designator 360a to draw the user's attention to where the NLP system found support to link the segment 320 with the key point shown in the third representation 340c. Additional details or key terms may be found in different segments 320, which when displayed may also include designators 360 around other relevant key terms. In various embodiments, the designators 360 can include different colors of text, colors of backgrounds, different typefaces, different font sizes, different font formats (e.g., underline, italics, boldface, etc.) or the like to draw attention to particular words from the transcript.

By highlighting the segment 320 believed to be the most-semantically-relevant segment 320 to a selected key point, the UI 300 provides the user with an easy way to navigate to relevant segments of the transcript to review surrounding information related to a core concept expressed by the key point. The UI 300 also provides insights into the factors that most influenced the determination that a given segment 320 is the “most-semantically-relevant” segment 320 so that the user can gain confidence in the underlying NLP system's accuracy or correct the misinterpreted segment 320 to thereby have a larger effect on improving the NLP system's accuracy in future analyses.

For example, the conversation presented in the UI 300 may include various ambiguities in interpreting the spoken utterances that the user may wish to fix. These ambiguities may include spoken-word to text conversions (e.g., did the speaker say “sea shells” or “she sells”), semantic relation matching (e.g., is pronoun₁ related to noun₁ or to noun), and relevancy ambiguity (e.g., is the first discussion of the key point more relevant than the second discussion?). By exposing the “most-semantically-relevant” segment 320 to a key point, the user can adjust the linkage between the given segment 320 and the key point to improve later access and review of the transcript, but also provide feedback to the NLP system related to the highest-weighted element from the transcript. Accordingly, the additional functionality provided by the UI 300 improves both the UX and the computational efficiency and accuracy of the underlying MLM models.

FIG. 3C illustrates a first reclassification action of the fourth segment 320d as not being the most-semantically-relevant segment 320 per user analysis and feedback of the transcript. For example, when presented with the UI 300 shown in FIG. 3B, if the user disagrees that the fourth segment 320d is the most-semantically-relevant segment 320 for the key point of “taking diphenhydramine three times daily”, the user may discard the linkage between the key point and the fourth segment 320d or otherwise lower the relative order of the linkage between the key point and the fourth segment 320d.

As illustrated, the user performs a “swipe” gesture 370a (generally or collectively, gesture 370) via a pointer device or touch screen to indicate that the fourth segment 320d is not considered (by the user) to be semantically relevant or the most-semantically-relevant to the selected key point. Additionally or alternatively, the user may use keyboard shortcuts, contextual commands, voice commands, or the like to dismiss a given segment 320 from being considered the most-semantically-relevant segment 320 or otherwise lower the relevancy of that segment 320 to be the “next-most” rather than the “most” semantically-relevant.

Once dismissed or otherwise lowered in the relative order of semantic relevancy, the UI 300 may update to show what was previously the next-most-semantically-relevant-segment 320 as the new most-semantically-relevant segment 320. For example, as is shown in FIG. 3F, if the third segment 320c was noted as the next-most-semantically-relevant-segment 320 after the fourth segment 320d (e.g., due to a first speaker stating that they take “an allergy pill with meals” compared to a second speaker stating the name of an allergy medication), when the user dismisses the fourth segment 320d, the UI 300 may automatically highlight the third segment 320c.

FIG. 3D illustrates a second reclassification action of the fourth segment 320d as not being the most-semantically-relevant segment 320 per user analysis and feedback of the transcript. For example, when presented with the UI 300 shown in FIG. 3B, if the user disagrees that the fourth segment 320d is the most-semantically-relevant segment 320 for the key point of “taking diphenhydramine three times daily”, the user can substitute or create a new linkage between the key point and a different segment 320 or otherwise increase the relative order of an indicated segment 320 to the key point over the previously indicated most-semantically-relevant segment 320.

As illustrated, the user has indicated that the third segment 320c is more semantically relevant than the fourth segment 320d to the key point for “taking diphenhydramine three times daily” by using a drag-and-drop gesture 370b. In various embodiments, the drag-and-drop gesture 370b may be performed with a pointing device or via a touch screen to select a new segment 320 to use as the most-semantically-relevant and move that segment 320 (or a UI element associated therewith) to the representation 340 of the key point that the new segment 320 is to be designated as most-semantically-relevant for. Although shown as dragging or swiping the third segment 320c towards the third representation 340c, the drag-and-drop gesture 370b may work in the reverse direction, where the user drags or swipes the third representation 340c towards the third segment 320c.

In various embodiments, when the user designates a new segment 320 as the most-semantically-relevant, the UI 300 automatically de-highlights the previous segment 320 and highlights the new segment 320, such as in FIG. 3F. Additionally, the re-ranking of the segments 320 can include a delinking or otherwise marking the previous most-semantically-relevant segment as irrelevant, or reducing the relative weight of the previous segment 320 to be the current “next-most-semantically-relevant” segment 320. This re-ranking is provided to the NLP system to improve the NLP system in making future relevancy determinations.

FIG. 3E illustrates a third reclassification action of the fourth segment 320d as not being the most-semantically-relevant segment 320 per user analysis and feedback of the transcript. For example, when presented with the UI 300 shown in FIG. 3B, if the user disagrees that the patient is “taking diphenhydramine three times daily”, the user may adjust the key point, which may cause the NLP system to reconsider which segment 320 is the most-semantically-relevant to the edited key point. Using the example conversation, if the user determines that the NLP system made a false assumption that the “allergy pill” mentioned by the speaker in the third segment 320c was “diphenhydramine” due to the speaker in the fourth segment 320d mentioning “diphenhydramine” as an “allergy medication”, the user can correct the key point to indicate that the allergy pill that the first speaker takes is actually unknown. In various embodiments, the user may provide edits via a keyboard, a dropdown menu, speech-to-text, a touchscreen, or the like.

In various embodiments, when the user designates a new segment 320 as the most-semantically-relevant, the UI 300 automatically de-highlights the previous segment 320 and highlight the new segment 320, such as in FIG. 3F. Additionally, the re-ranking of the segments 320 can include a delinking or otherwise marking the previous most-semantically-relevant segment as irrelevant, or reducing the relative weight of the previous segment 320 to be the current “next-most-semantically-relevant” segment 320. This re-ranking is provided to the NLP system to improve the NLP system in making future relevancy determinations.

FIG. 3F illustrates a subsequent selection of the third representation 340c in the UI 300 after receiving a reclassification from a user. Similarly to the initial selection shown in FIG. 3B, the UI 300 updates the display to include various contextual controls 350a-b or highlight related elements in the UI 300 to the selected element. However, the feedback received from the user regarding which segment 320 is the most-contextually-relevant segment 320 has updated which segments 320 to link with which representations 340. Accordingly, when selecting the third representation 340c after a user updates the semantic relevance as per FIG. 3C, 3D, or 3E, the UI 300 updates to include the first contextual controls 350a in association with the third representation 340c and adjusts the display of the transcript to highlight the third segment 320c as the most-semantically-relevant segment 320 to the selected representation 340, rather than the initially determined fourth segment 320d.

FIGS. 4A-4G illustrate interactions with a UI 400 that includes a transcript and analysis outputs from a conversation (such as, but not limited to, the conversation 120 discussed in relation to FIG. 1) for a second user type, according to embodiments of the present disclosure. Using the example conversation 120 from FIG. 1, the UI 400 illustrated in FIGS. 4A-4G shows a perspective for a patient-adapted interface, whereas the UI 300 illustrated in FIGS. 3A-3F shows a perspective for a caregiver-adapted interface.

FIG. 4A illustrates a first state of the UI 400, as may be provided to a user after initial analysis of an audio recording of a conversation by an NLP system. The transcript is shown in a transcript window 410, which includes several segments 420a-420e (generally or collectively, segment 420) identified within the conversation. In various embodiments, the segments 420 may represent speaker turns in the conversation, sentences identified in the conversation, topics identified in the conversation, a given length of time in the conversation (e.g., every X seconds), combinations thereof, and other divisions of the conversation.

The segments 420 may divided or grouped identically to those shown in the perspectives for other users, or may be divided or grouped per individualized preferences. Accordingly, although the segments 420 in FIGS. 4A-4G are identical to the segments 320 in FIGS. 3A-3F, the present disclosure contemplates using different segmentation schemes or layouts for different users referencing the same conversation.

Each segment 420 includes a portion of the written text of the transcript, and provides a UI element that allows the user to access the corresponding audio recording, make edits to the transcript, zoom in on the text, and otherwise receive additional detail for the selected portion of the conversation. Although the transcript illustrated in FIGS. 4A-4G includes the entire conversation 120 given as an example in FIG. 1, in various embodiments, the UI 400 may omit portions of the transcript from initial display. For example, the UI 400 may initially display only the segments 420 from which key terms have been identified or key points have been extracted (e.g., to skip introductory remarks or provide a summary), with the non-displayed segments 420 being omitted from display (e.g., positioned “off screen” for later access), shown as thumbnails, etc.

In various embodiments, additional data or metadata related to the segment 420 (e.g., speaker, topic, confidence in written text accurately matching input audio, whether edited by a user) can be presented based on color or shading of the segment 420 or alignment of the segment 420 in the transcript window 410. For example, the first segment 420a, the third segment 420c, and the fifth segment 420e are shown as left-aligned versus the second segment 420b and the fourth segment 420d, which are shown as right-aligned, which indicates different speakers for the differently aligned segments 420. In another example, the fifth segment 420e is displayed with a different shading than the other segments 420, which may indicate that the NLP system is confident that human error is present in the fifth segment 420e, that the NLP system is not confident in the transcribed words matching the spoken utterance, or another aspect of the fifth segment 420e that deserves additional attention form the user.

Depending on the display area available to present the UI 400, the transcript window 410 may include some or all of the segments 420 at a given time. Accordingly, although not illustrated, in various embodiments, the transcript window 410 may include various content controls (e.g., scroll bars, text size controls, etc.) to enable access to more content than can be legibly displayed at one time on the device outputting the UI 400. For example, content controls can allow a user to scroll to currently off-screen elements, zoom in on elements below a size threshold or presented as thumbnails when not selected, or the like.

Outside of the transcript window 410, the UI 400 displays categorized analysis outputs in an analysis window 480 in one or more categories 430a-c (generally or collectively, category 430). The categories 430 include various selectable representations 440a-f (generally or collectively, representations 440) of key points extracted from the conversation, and analysis outputs related to those key points.

For example, under a first category 430a of “conditions discussed”, the UI 400 includes a first representation 440a of a key point classified as related to “conditions discussed” extracted from the conversation. Other key points extracted from the conversation are classified into other categories 430, such that the key point for various medications that are classified under the second category 430b for “medications”, and the key points for follow up actions to take after the conversation a under the fourth category 330d for “follow up”.

In various embodiments, the key points include direct words or phrases extracted from the transcript, but may also include inherent or suggested terms. For example, because the patient and Dr. Smith did not explicitly discuss a follow up appointment to check back on the symptoms discussed in the conversation, the NLP system may infer or automatically generate a pseudo-key term to use in extracting a key point to follow up if conditions worsen when no specific follow up plan is presented.

Although the UI 400 illustrated in FIGS. 4A-4G displays categorized results from the same conversation as the UI 300 illustrated in FIGS. 3A-3F, the categories 430 are different from the categories 330 shown in FIGS. 3A-3F, and the corresponding representations 440 are different from the representations 340 shown in FIGS. 3A-3F. Accordingly, for the same conversation, the UI 400 may show different orders and types of the representations 440 based on which categorization scheme is selected by the user.

FIG. 4B illustrates selection of the fifth representation 440e in the UI 400. When a user, via input from one or more of a keyboard, pointing device, or touch screen, selects a representation 440, the UI 400 may update the display to include various contextual controls 450a-b or highlight related elements in the UI 400 to the selected element. For example, when selecting the fifth representation 440e, the UI 400 updates to include first contextual controls 450a in association with the fifth representation 440c to allow editing or further interaction with the underlying key point and analysis thereof.

Additionally, the UI 400 adjusts the display of the transcript to highlight the most-semantically-relevant segment 420 to the selected representation 440 for a key point. When highlighting the most-semantically-relevant segment 420, the UI 400 may increase the size of the most-semantically-relevant segment 420 relative to the other segments, as shown in FIG. 4B, but may also change the color, apply an animation effect, scroll which segments 420 are displayed (and where) within the transcript window 410, and combinations thereof to highlight the most-semantically-relevant segment 420 to the selected representation 440. In various embodiments, each representation 440 includes a hyperlink to the corresponding most-semantically-relevant segment 420 that includes the location of the most-semantically-relevant segment 420 within the transcript and any effects (e.g., color, animation, resizing, etc.) to apply to the corresponding segment 420 to highlight it as the most-semantically-relevant segment 420 for the selected representation 440.

As illustrated, the UI 400 adds second contextual controls 450b in association with the fourth segment 420d to provide additional information about the highlighted segment 420 to the user, and provide controls for the user to further interact with or edit the associated portion of the transcript.

When a segment 420 is highlighted, the UI 400 may display various designators 460a-c (generally or collectively, designator 460) for words of phrases found in the highlighted segment 420 that have been identified as key terms related to the key point in the selected representation 440. For example, the selected fifth representation 440c represents key points identified from the transcript related to “start Vertigone”, and the information extracted from the transcript includes the utterances for “Vertigone” and “vertigo” shown in the fourth segment 420d. Accordingly, the word “Vertigone” shown in the fourth segment 420d is displayed with a first designator 460a and a second designator 460b to draw the user's attention to where the NLP system found support to link the segment 420 with the key point shown in the fifth representation 440e.

By highlighting the segment 420 believed to be the most-semantically-relevant segment 420 to a selected key point, the UI 400 provides the user with an easy way to navigate to relevant segments of the transcript to review surrounding information related to a core concept expressed by the key point. The UI 400 also provides insights into the factors that most influenced the determination that a given segment 420 is the “most-semantically-relevant” segment 420 so that the user can gain confidence in the underlying NLP system's accuracy or correct the misinterpreted segment to thereby have a larger effect on improving the NLP system's accuracy in future analyses.

For example, the conversation presented in the UI 400 may include various ambiguities in interpreting the spoken utterances that the user may wish to fix. These ambiguities may include spoken-word to text conversions (e.g., did the speaker say “sea shells” or “she sells”), semantic relation matching (e.g., is pronoun₁ related to noun₁ or to noun), and relevancy ambiguity (e.g., is the first discussion of the key point more relevant than the second discussion?). By exposing the “most-semantically-relevant” segment 420 to a key point, the user can adjust the linkage between the given segment 420 and the key point to improve later access and review of the transcript, but also provide feedback to the NLP system related to the highest-weighted element from the transcript. Accordingly, the additional functionality provided by the UI 400 improves both the UX and the computational efficiency and accuracy of the underlying MLM models. Additionally, by providing different UIs to different users, different relative weights of importance of various conversational data for different user types can be determined.

FIG. 4C illustrates selection of the first contextual controls 450a to select a “more” option. Depending on the category 430 to which the selected representation 440 belongs and the contents of the selected representation 440, the “more” option can provide different options for a user to select between, based on the context in which the representation 440 is presented in the UI 400.

For example, selection of the “more” option for the fifth representation 440e may include an option to call a pharmacy, as the fifth representation 440e includes context related to performing future actions related to a medication (e.g., “follow up” to “start Vertigone”). However, if the user were to select the “more” option for the sixth representation 440f, an option to call a physician's office may be provided instead of an option to call a pharmacy, as the sixth representation 440f includes context related to performing future actions related to a physician's office (e.g., “follow up” by “calling Dr. Smith if conditions worsen”) and not a pharmacy.

In various embodiments, the representations 440 can include recall hyperlinks to other transcripts aside from the transcript currently displayed in the transcript window 410 in addition to or instead of hyperlinks to the most-relevant-segment 420 of the currently displayed transcript. For example, for the fourth representation 440d related to the key point for “no longer taking Kyuritol due to nausea”, the NLP system may include a hyperlink in the “more” option to allow the user to link to an earlier conversation related to Kyuritol (e.g., the appointment when the patient was taken off of Kyuritol). Accordingly, the UI 400 may provide a user with access to historical conversations that provide additional context to the current conversation by linking a current instance and an earlier instance of a related key point between different conversations.

FIG. 4D illustrates selection of the first contextual controls 450a to select an “explain” option. In response to the user selecting the “explain” option the UI 400 updates to provide a contextual pane 490 that provides additional explanatory details or a definitional description related to one or more terms found in the representation 440 that may be unfamiliar terms to the user. As shown in FIG. 4D, the contextual pane 490 shows additional details related to what “Vertigone” is in response to the user selecting the “explain” option from the first contextual controls 450a.

FIG. 4E illustrates selection of a designator 460 within a segment 420. In response to a user selecting the designator 460, the UI 400 updates to provide a contextual pane 490 that provides additional explanatory details or a definitional description related to one or more terms found in the designator 460 that may be unfamiliar terms to the user. As shown in FIG. 4E, the contextual pane 490 shows additional details related to what “vertigo” is in response to the user selecting the second designator 460b from the fourth segment 420d.

In various embodiments, the NLP system identifies what terms are considered “unfamiliar” based on a user profile, a frequency analysis of a corpus of words, a presence of an unfamiliarity flag on the term in a key word dictionary, and combinations thereof. For example, the individual words “Vertigone” and “vertigo” may be noted in a key word dictionary used by the SR system as a term requiring explanation, may be noted as appearing below a familiarity threshold number of times across a corpus of words identifiable by the SR system, and the user may be noted as not familiar with pharmacological terms, which all can indicate that the terms “Vertigone” and “vertigo” should be considered an unfamiliar term for the user.

In various embodiments, the contents of the contextual pane 490 may include preloaded content transferred along with the transcript to the user device displaying the UI 400, or may include links to fetch external data, from a third-party web site or a managed definition library when a user selects an “explain” option from the contextual controls 450 (as per FIG. 4D) or selects a designator 460 (as per FIG. 4E).

Additionally or alternatively to providing definitional data via contextual panes 490 that are activated in response to a selection from a contextual control 450 or designator 460, the UI 400 may provide a separate category 430 for unfamiliar terms. When the UI 400 provides a “definitions” category 430, this category 430 can include representations 440 that recite the unfamiliar term and, when selected by a user, provide an associated contextual pane 490 with the additional explanation of that unfamiliar term.

FIG. 4F illustrates a reclassification action of the fourth segment 420d as not being the most-semantically-relevant segment 420 per user analysis and feedback of the transcript. For example, when presented with the UI 400 shown in FIG. 4B, if the user disagrees that the fourth segment 420d is the most-semantically-relevant segment 420 for the key point of “start Vertigone”, the user may discard the linkage between the key point and the fourth segment 420d or otherwise lower the relative order of the linkage between the key point and the fourth segment 420d. For example, the user may not wish to know why Vertigone was selected from among the options presented in the fourth segment 420d, but prefers to remember what the underlying reason that led to the recommendation to start Vertigone was. Accordingly, the user is shown selecting the first segment 420a that contains the initial complaint of “My dizziness is getting worse” as what the user considers relevant to the key point to follow up by starting a regimen of Vertigone.

As illustrated, the user performs a “swipe” gesture 470 via a pointer device or touch screen to indicate that the first segment 420a is considered (by the user) to be more semantically relevant to the selected key point than the fourth segment 420d, that the analysis system initially identified as being the most semantically relevant. Additionally or alternatively, the user may use keyboard shortcuts, contextual commands, voice commands, or the like to delink a given segment 420 from being considered the most-semantically-relevant segment 420 or otherwise lower the relevancy of that segment 420 to be the “next-most” rather than the “most” semantically-relevant. Although shown as dragging or swiping the first segment 420a towards the fifth representation 440e, the gesture 470 may work in the reverse direction, where the user drags or swipes the fifth representation 440e towards the first segment 420a.

FIG. 4G illustrates a subsequent selection of the fifth representation 440e in the UI 400 after receiving a reclassification from a user. Similarly to the initial selection shown in FIG. 4B, the UI 400 updates the display to include various contextual controls 450a-b or highlight related elements in the UI 400 to the selected element. However, the feedback received from the user regarding which segment 420 is the most-semantically-relevant segment 420 has updated which segments 420 to link with which representations 440. Accordingly, when selecting the fifth representation 440c after a user updates the semantic relevance as per FIG. 4F, the UI 400 updates to include the first contextual controls 450a in association with the fifth representation 440c and adjusts the display of the transcript to highlight the first segment 420a as the most-semantically-relevant segment 420 to the selected representation 440, rather than the initially determined fourth segment 420d.

The different perspectives in FIGS. 3A-3F and FIGS. 4A-4G may be provided by different MLMs based off of the same transcript and conversation or based on different transcripts of the same conversation. For example, the NLP system may generate a unique transcript for each participant, where each transcript is initially the same, but may receive independent and different edits from the different users via associated UIs.

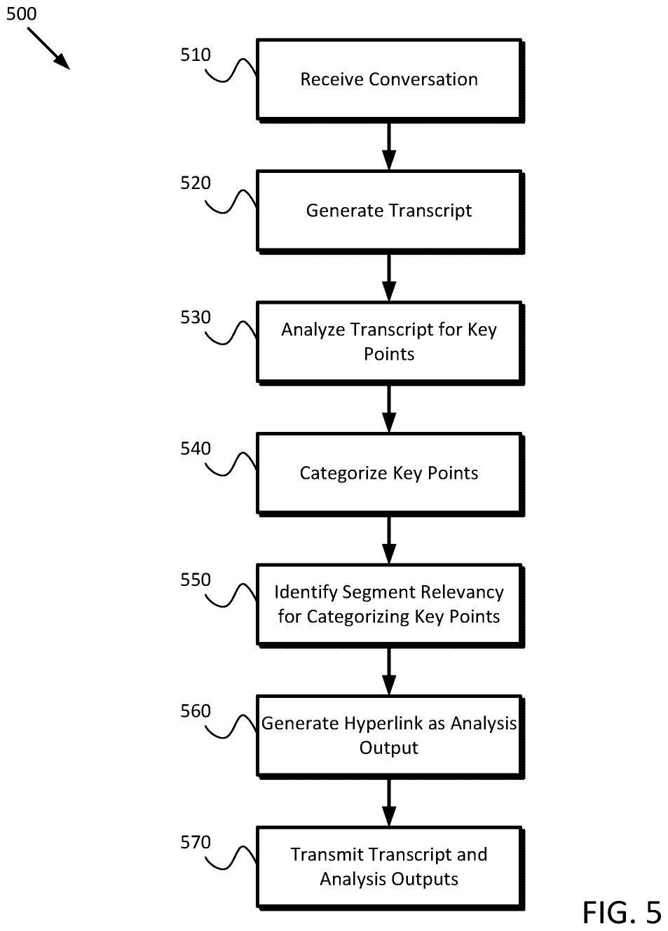

FIG. 5 is a flowchart of a method 500 for generating content to include in a UI (such as, but not limited to, the UI 300 discussed in relation to FIGS. 3A-3F or the UI 400 discussed in relation to FIGS. 4A-4G), according to embodiments of the present disclosure.

Method 500 begins with block 510, where an NLP system (such as the NLP system including the speech recognition system 220 and analysis system 230 discussed in relation to FIG. 2) receives a conversation that includes utterances spoken by two or more parties. In various embodiments, the recording may be received from a user device associated with one of the parties, and may include various metadata regarding the conversation. Such metadata may include one or more of: the identities of one or more parties, a location where the conversation took place, a time where the conversation took place, a name for the conversation or recording, a user-selected topic of the conversation, whether additional audio sources exist for the same conversation or portions of the conversation (e.g., whether two or more parties are submitting separate recordings of one conversation), etc.

At block 520, a speech recognition system or layer of the NLP system generates a transcript of the conversation included in the recording received at block 510. In various embodiments, the speech recognition system may perform various pre-processing analyses on the audio of the recording to remove background noise or non-speech sounds to aid in analysis of the recording, or may receive the recording having already been processed to emphasize speech. The speech recognition system applies various attention-based models to identify the written words corresponding to the spoken phonemes in the recording to produce a transcript of the conversation. In addition to the phoneme matching, the speech recognition system uses the syntactical and grammatical relationship between the candidate words to identify an intent of the utterance and thereby select words that better match a valid and coherent intent for the natural language speech included in the recording. Additionally, in embodiments that include emotion detection for the speaker, the system can use the detected emotion to better identify the spoken words and syntax thereof (e.g., differentiating literal vs. sarcastic intent).

In various embodiments, the speech recognition system may clean up verbal miscues, add punctuation to the transcript, and divide the conversation into a plurality of segments to provide additional clarity to readers. For example, the speech recognition system may remove verbal fillers (e.g., “um”, “uh”, etc.), expand shorthand terms, replace or supplement jargon terms with more commonplace synonyms, or the like. The speech recognition system may also add punctuation based on grammatical rules, pauses in the conversation, rising or falling tones in the utterances, or the like. In some embodiments, the speech recognition system uses the various sentences (e.g., identified via the added punctuation) to divide the conversation into segments, but may additionally or alternatively use speaker identities, shared topics/intents, and other features of the conversation to divide the conversation into segments.

At block 530, an analysis system or layer of the NLP system analyzes the transcript of the conversation to identify one or more key terms across the segments of the transcript. In various embodiments, the analysis system identifies key terms based on term-matching the words of the transcript to predefined terms in a key term dictionary or other list. Additionally, because key terms may include multipart phrases, pronouns, or the like, the analysis system analyzes the transcript for nearby elements related to a given key term to provide a fuller meaning for a given term than term matching.

For example, when the word “battery” is identified as a key term and is found in the transcript based on a dictionary match, the analysis system analyzes the sentence that the term is found in, and optionally one or more surrounding sentences before or after the current sentence, to determine whether additional details can better define what the “battery” refers to. The analysis system may thereby determine whether the term “battery” is related to a series of tests, a voltage source, a location, a physical altercation, or a pitching/catching team in baseball, and marks the intended meaning of the key term accordingly. In another example, when the word “appointment” is identified as a key term and is found in one sentence of the transcript, the analysis system may look for related terms (e.g., days, times, relative time terminology) in the current sentence or surrounding sentences to identify whether the appointment refers to the current, past, or future event, and when that event is occurring, has occurred, or will occur.

When identifying the key terms from the transcript, the analysis system may group one or more key terms with supporting words from the transcript to provide a semantically legible summary as a “key point” of that portion of the conversation. For example, instead of merely identifying “battery” and “appointment” as key terms related to the “plan” category, the analysis system may provide a grouped analysis output of “battery replacement appointment next week” to provide a summary that meets the design goals of sufficiency, minimality, and naturalness in presentation of a key point of the conversation. In various embodiments, each key term may be used as a key point if the analysis system cannot identify additional related key terms or supporting words from the transcript to use in conjunction with a lone key term or determines that the key term is sufficient on its own to convey a core concept of the conversation.

At block 540, the analysis system or layer of the NLP system categorizes each of the identified key points into corresponding categories out of a plurality of potential categories for the contextual relevance of those key points. The analysis system uses the semantic context of the sentence (and surrounding sentences) to identify the semantic context of the key point. Using the previous examples of “battery” and “appointment”, the analysis system may determine that one speaker is attempting to schedule a time in the future where a voltage source of a pacemaker is to be replaced. Depending on what categories the user has selected to group the key points into, the key point related to the terms for “battery” and “appointment” may be categorized as part of a “plan” or “follow up” (e.g., based on the desire to replace the battery being a future action), an “assessment” or “condition discussed” (e.g., based on the need to replace the current battery), or the like.

The analysis system may be configured to analyze various candidate categories to group the key points into, and scores each key point in a vector space with various features related to each candidate category. When a key point has a relevancy score above a relevancy threshold in the associated dimension for a given category, and that category has the highest value for the key point, the analysis system categorizes that key point as being related to the given category.

In various embodiments, the available categories include a “null” or “unrelated” category to receive any key points that do not otherwise fall into another category or satisfy a certainty threshold for any category. For example, if the analysis system is set up to analyze conversations to track “battery” as a key term when related to series of tests, voltage sources, or physical altercations, if insufficient semantic details for these meanings are present in the conversation, or sufficient semantic details for the term being used in relation to a location or baseball team are found, the analysis system may that the key term is not relevant to a tracked category for key points, or otherwise classify any key point extracted based on the key term into an “unrelated” category.

At block 550, the analysis system or layer of the NLP system identifies segment relevancy for categorizing the key points to identify, and rank, the various segments used to categorize the key points to the various candidate categories per block 540. In various embodiments, the analysis system identifies which segment was most relevant to categorizing the key point to the currently assigned category (e.g., a most-semantically-relevant segment) and any segments of subsequent relevance (e.g., a second-most or otherwise next-most-semantically-relevant segment).

In some embodiments, the analysis system also identifies the most-semantically-relevant and next-most-semantically-relevant segments for one or more categories that the key point was not classified into, but satisfied a certainty threshold for. For example, if the term “battery” could be classified into an “assessment” or “plan” category based on satisfying a certainty threshold for each category, but scored higher on the dimensions for the “plan” category, the analysis system identifies the most-semantically-relevant segment for (actual) classification into the “plan” category, but also the most-semantically-relevant segment for (potential) classification into the “assessment” category.

Due to the interrelated yet unstructured nature of human speech, the analysis system may identify two or more key points that share the same segment as the most-semantically-relevant segment, and the two or more key point may be categorized into the same or different categories.

At block 560, the analysis system or layer of the NLP system generates hyperlinks between the key points and various segments of the conversation as analysis outputs. In various embodiments, the hyperlink generated for a key point links the key point with the most relevant segment identified per block 550 to allow a user (on selection of a UI element presenting the hyperlink) to highlight the most-semantically-relevant segment and thereby navigate the transcript to the portion identified by the underlying MLMs of the NLP system as being important to the decision to categorize the key point into a current category. The hyperlinks may include the location of the most-semantically-relevant segment within the transcript (e.g., by timestamp, segment number, start-word, etc.), any effects (e.g., color, animation, resizing, etc.) to apply to highlight the associated segment from the other segments, and any secondary segments to include if the user rejects or dismisses the categorization to provide as alternatives to the NLP-determined most-semantically-relevant segment (e.g., the next-most-semantically-relevant segment).

In various embodiments, the analysis system may produce additional analysis outputs, such as those discussed in relation to FIG. 2 in addition to the relevant-segment hyperlinks. For example, the analysis system may identify when a key term also classified as an “unfamiliar” term for a user. The analysis system may use a user profile, a frequency analysis of a corpus of words, a presence of an unfamiliarity flag on the term in a key word dictionary, and combinations thereof to identify unfamiliar terms for a given user. For example, when a first user profile indicates that a first participant in the conversation is marked as a technical expert, and a second user profile indicates that a second participant in the conversation is marked as a technical novice, the analysis system may identify different terms as unfamiliar when each user requests the transcript.

When an unfamiliar term is identified, the analysis system generates a definition hyperlink (as an analysis output) between the unfamiliar term and a definitional description of that term. In various embodiments, the unfamiliar term may be present in a categorization or summary of the key point or a segment of the transcript, and the definitional hyperlink may link the unfamiliar term with a definitional description provided along with the transcript, or to an outside source for explanatory details (e.g., a third party website hosting a definition or explanation related to the unfamiliar term).

In an additional example, the analysis system may identify when a key point is present across multiple conversations to link those conversations via a recall hyperlink. The analysis system may analyze earlier transcripts that include the same participants, or that are designated as linked by one or more users, to identify earlier instances of a key point found in the current conversation that are also found in the earlier conversations that were spoken or analyzed before the present conversation. For example, a patient may wish to link an earlier conversation held with a general practitioner with a later conversation held with a referred specialist, or a technician may wish to link conversations related to repairs and scheduled maintenance for a given mechanical system over time. Accordingly, the analysis system may identify shared key points in the multiple conversations and generate a recall hyperlink between the current instance of the key point and the earlier instance of the key point to allow the user to navigate between relevant and related segments of each conversation.

At block 570, the NLP system transmits the transcript and the analysis outputs to a user device. In various embodiments, the NLP system pushes the transcript and analysis outputs (including the hyperlinks) to a user device in response to a request for transcription and analysis that initiated method 500. In some embodiments, the NLP system stores the transcript and analysis outputs (including the hyperlinks) to a storage system associated with a user account of a requestor who initiated method 500, which may provide the transcript and/or analysis outputs to authorized parties including the initial requestor and others authorized by the requestor to access the transcript and/or analysis outputs.

Method 500 may then conclude.

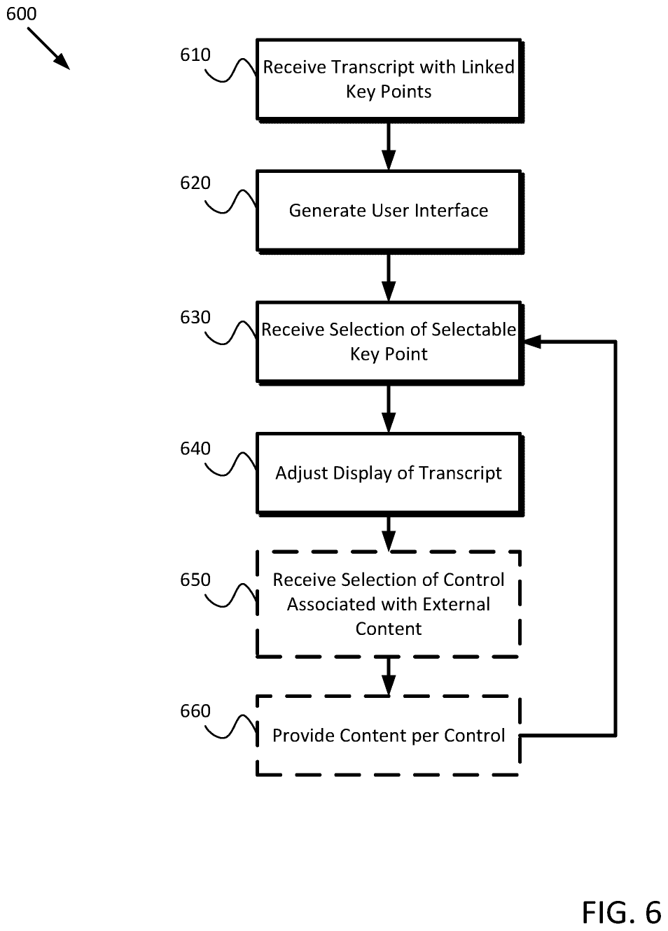

FIG. 6 is a flowchart of a method 600 for populating and navigating a UI (such as, but not limited to, the UI 300 discussed in relation to FIGS. 3A-3F or the UI 400 discussed in relation to FIGS. 4A-4G), according to embodiments of the present disclosure.

Method 600 begins with block 610, where a user device receives a transcript with one or more linked key points. In various embodiments, the user device may be any computing device associated with a user (such as the computing device 800 discussed in relation to FIG. 8), and the transcript and linked key points may be received directly from an NLP system (such as the NLP system including the speech recognition system 220 and analysis system 230 discussed in relation to FIG. 2) or a storage system accessed via user profile.

At block 620, the user device generates a display of a UI that includes the transcript, the various categories in which the key points have been categorized, and selectable representations of the key points included in the associated categories. The user device adapts the size, orientation, and initially displayed content in the UI based on the form factor and available screen space of a display device to thereby display the UI according to user preferences for reading the content in the UI. Accordingly, some elements of the UI may be displayed on-screen, while some elements remain off-screen and are accessible by various user commands (e.g., invoking contextual controls, scrolling, navigating via hyperlinks, accessing menus, etc.).

At block 630, the user device receives a selection of a selectable representation of a key point from the UI. In various embodiments, the user may make a selection via touchscreen, hardware (e.g., keyboard or mouse), or speech input to indicate that a particular representation presented in the UI is of interest to the user.

At block 640, the user device adjusts display of the transcript in the UI in response to the selection received in block 630.

In various embodiments, the hyperlink associated with the key point represented by the selectable representation identifies a segment in the transcript identified as the most-semantically-relevant segment to the key point by an NLP system that generated the transcript. Additionally, the hyperlink may identify various actions to perform in the UI to highlight that segment to the user. In various embodiments, the user device may adjust the UI by scrolling the transcript to display the linked-to segment, increase the relative size of the linked-to segment in the UI (relative to the other segments by increasing and/or decreasing the various segment sizes), apply a different color to the linked-to segment (relative to the other segments), apply an animation effect, or combinations thereof.

In some embodiments, the hyperlink associated with the key point represented by the selectable representation is linked with content outside of the transcript, which may include definitional details, or earlier conversations linked via related key points. Accordingly, method 600 (optionally) proceeds to block 650 when the user device receives selection of a control associated with content external to the transcript of the current conversation.

At block 660, the user device provides content according the selected control. In various embodiments, the external content is provided in a contextual pane in association with the selected key point or element from the current transcript. For example, external content of a definitional description may be provided when a control associated with a key term designated an unfamiliar term is selected, which may be fetched from a third-party website indicated in a definitional hyperlink or recalled from a definition provided with the transcript. In another example, external content of a most-relevant segment of an earlier conversation may be provided when a user actuates a control associated with an instance of a key point linked with an earlier instance of that key point from the earlier conversation. The recall hyperlink may indicate the segment from the earlier conversation designated as most-semantically-relevant to the earlier instance of the key point, and link to the relevant portion of the transcript of the earlier conversation or include a stored version of the segment from the earlier conversation included with the current transcript.

Method 600 may then conclude, or return to block 630 in response to a subsequent selection of a selectable representation of a key point.

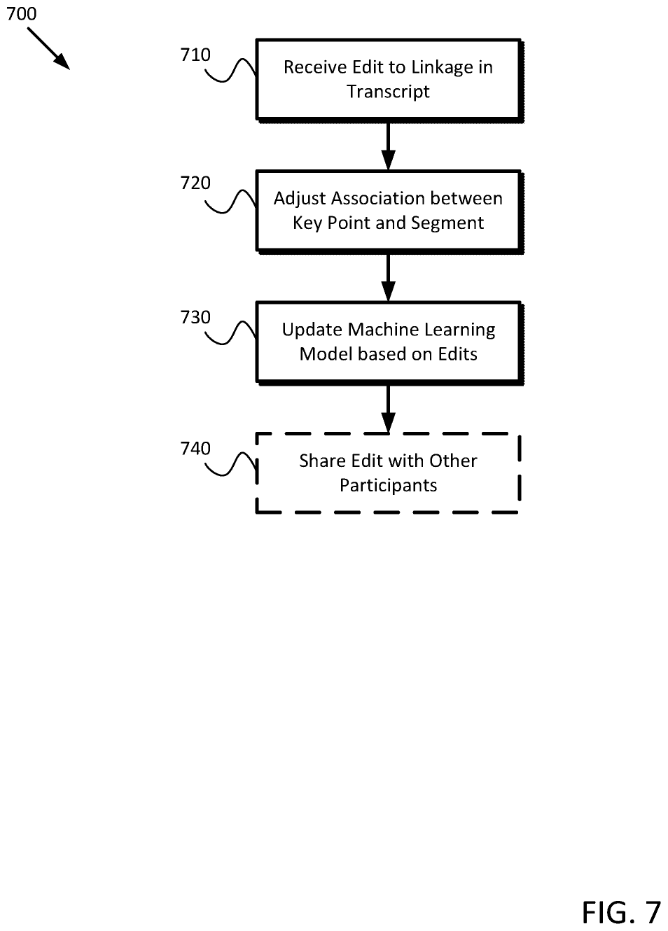

FIG. 7 is a flowchart of a method 700 for reacting to user edits to a transcript made in a UI (such as, but not limited to, the UI 300 discussed in relation to FIGS. 3A-3F or the UI 400 discussed in relation to FIGS. 4A-4G), according to embodiments of the present disclosure.

Method 700 begins with block 710, where a user device receives (via the UI) an edit to a linkage between a key point and a segment of the transcript designated as the most-semantically-relevant segment of the transcript for that key point. In various embodiments, the user device may be any computing device associated with a user (such as the computing device 800 discussed in relation to FIG. 8), and the transcript and linked key points may be received directly from an NLP system (such as the NLP system including the speech recognition system 220 and analysis system 230 discussed in relation to FIG. 2) or a storage system accessed via user profile.

In various embodiments, the edit to the linkage can include the dismissal of the linkage as not being the most-semantically-relevant segment of the transcript, or can include an update of which segment is considered by the user to be more semantically-relevant than the currently indicated most-semantically-relevant segment. Additionally or alternatively, the edit to the linkage can include changes to the transcript or categorized key points that alter whether a segment includes semantically relevant information to the key point, which may serve as a dismissal of the linkage or a command to an NLP system to reanalyze the transcript for semantically relevant portions.

At block 720, the user device adjusts the association between the key point and the segments of the transcript based on the edits received in block 710.

When the edit is a dismissal of the linkage as being the most-semantically-relevant segment of the transcript, the user device may redirect the hyperlink between the key point and the currently linked segment and a segment designated as a next-most-semantically-relevant segment. If a next-most-semantically-relevant segment is not known to the user device (e.g., not included as a secondary target in an original hyperlink), the user device may query the NLP system for the next-most-semantically-relevant segment relative to the current most-semantically-relevant segment, or remove the hyperlink until a new segment is identified to link with.

When the edit is an update to the linkage for a different segment being the most-semantically-relevant segment of the transcript, the user device may redirect the hyperlink between the key point and the currently linked segment and a segment designated by the user as more semantically-relevant to the key point. In various embodiments, the user-indicated segment replaces the previous most-semantically-relevant segment as a primary target in the hyperlink, which may, in turn be removed from the hyperlink or replace a next-most-semantically-relevant segment as a second (tertiary, or subsequent) target in the hyperlink.

When the edit is an update to the words in the transcript or categorized key point, the user device may redirect the hyperlink between the key point and the currently linked segment and a segment designated by the NLP system as the most-relevant for a different category, may remove the hyperlink until the NLP system has reanalyzed which segment should be considered the most-semantically-relevant based on the updated wording, or may leave the hyperlink in place until the NLP system has reanalyzed which segment should be considered the most-semantically-relevant based on the updated wording.

At block 730, the user device transmits the edits to the NLP system used to analyze the transcript for key points to update the MLM used to determine semantic relevancy within the transcript. In various embodiments, the MLM uses the edit as supervised or semi-supervised feedback to adjust various training weighting factors or certainty thresholds to identify what category a key point belongs to, or the relevancy of a given segment in categorizing that key point.

For example, the user device may indicate to the NLP system that a segment dismissed as the most-relevant should be deemphasized in future analyses or added to a training set as an example or specimen of a “not-most-relevant” segment. In another example, the user device may indicate that a segment replaced by a different segments as the “most-semantically-relevant” should be deemphasized in future analyses or added to a training set as an example or specimen of a “not-most-relevant” segment and/or that the different segment should be emphasized in future analyses or added to a training set as an example of a “most-relevant” segment.

At block 740, the user device or the NLP system (optionally) shares the edits with other participants of the conversation or other parties with access to the recorded conversation. For example, an edit made by a doctor to a transcript of a conversation with a patient may be shared with the patient to allow updates made by the doctor, or portions of the conversation emphasized by the doctor as important or relevant, to be shared with the doctor. However, the user device or the NLP system may also be configured to keep individual user's edits to the transcript or linkages between key portions and segments of the transcript private to the individual user who made those edits. Accordingly, method 700 may omit block 740 in some embodiments.

Method 700 may then conclude.

FIG. 8 illustrates an example computing device 800 according to embodiments of the present disclosure. The computing device 800 may include at least one processor 810, a memory 820, and a communication interface 830.

The processor 810 may be any processing unit capable of performing the operations and procedures described in the present disclosure. In various embodiments, the processor 810 can represent a single processor, multiple processors, a processor with multiple cores, and combinations thereof.

The memory 820 is an apparatus that may be either volatile or non-volatile memory and may include RAM, flash, cache, disk drives, and other computer readable memory storage devices. Although shown as a single entity, the memory 820 may be divided into different memory storage elements such as RAM and one or more hard disk drives. As used herein, the memory 820 is an example of a device that includes computer-readable storage media, and is not to be interpreted as transmission media or signals per se.

As shown, the memory 820 includes various instructions that are executable by the processor 810 to provide an operating system 822 to manage various functions of the computing device 800 and one or more programs 824 to provide various functionalities to users of the computing device 800, which include one or more of the functions and functionalities described in the present disclosure. One of ordinary skill in the relevant art will recognize that different approaches can be taken in selecting or designing a program 824 to perform the operations described herein, including choice of programming language, the operating system 822 used by the computing device, and the architecture of the processor 810 and memory 820. Accordingly, the person of ordinary skill in the relevant art will be able to select or design an appropriate program 824 based on the details provided in the present disclosure.

Additionally, the memory 820 can include one or more of machine learning models 826 for speech recognition and analysis, as described in the present disclosure. As used herein, the machine learning models 826 may include various algorithms used to provide “artificial intelligence” to the computing device 800, which may include Artificial Neural Networks, decision trees, support vector machines, genetic algorithms, Bayesian networks, or the like. The models may include publically available services (e.g., via an Application Program Interface with the provider) as well as purpose-trained or proprietary services. One of ordinary skill in the relevant art will recognize that different domains may benefit from the use of different machine learning models 826, which may be continuously or periodically trained based on received feedback. Accordingly, the person of ordinary skill in the relevant art will be able to select or design an appropriate machine learning model 826 based on the details provided in the present disclosure.

The communication interface 830 facilitates communications between the computing device 800 and other devices, which may also be computing devices 800 as described in relation to FIG. 8. In various embodiments, the communication interface 830 includes antennas for wireless communications and various wired communication ports. The computing device 800 may also include or be in communication, via the communication interface 830, one or more input devices (e.g., a keyboard, mouse, pen, touch input device, etc.) and one or more output devices (e.g., a display, speakers, a printer, etc.).

The present disclosure may also be understood with reference to the following numbered clauses.

Clause 1: A method for performing various operations, a system including a processor and a memory device including instructions that when executed by the processor perform various operations, or a memory device that includes instructions that when executed by a processor perform various operations, wherein the operations comprise: analyzing a transcript of a conversation, by a Natural Language Processing (NLP) system, to identify a key point and a plurality of segments from the transcript that provide a semantic context for the key point within the conversation; categorizing, by the NLP system, the key point into a selected category of a plurality of categories for contextual relevance based, at least in part, on the semantic context for the key point; identifying, by the NLP system, a most-semantically-relevant segment of the plurality of segments; generating a hyperlink between the key point within the most-semantically-relevant segment of the transcript; and transmitting, to a user device, the transcript and the hyperlink.

Clause 2: The operations described in any of clauses 1 or 3-9, further comprising, before analyzing the transcript: receiving an audio recording of the conversation including a first plurality of utterances spoken by a first party and a second plurality of utterances spoken by a second party, wherein the user device is associated with one of the first party or the second party; and generating, by a speech recognition system of the NLP system, the transcript of the conversation.

Clause 3: The operations described in any of clauses 1-2 or 4-9, further comprising: analyzing the transcript, by an analysis system of the NLP system, for a second key point and the segments from the transcript that provide second semantic context for the second key point within the conversation; categorizing, by the analysis system, the second key point into a second category of the plurality of categories for contextual relevance based on the second semantic context for the second key point; identifying, by the analysis system, that the most-semantically-relevant segment for the key point is also a most-semantically-relevant second segment for the second key point for categorizing the second key point to the second category; generating a second hyperlink between the key point within the second category and the most-semantically-relevant second segment of the transcript; and transmitting, to the user device, the second hyperlink.

Clause 4: The operations described in any of clauses 1-3 or 5-9, further comprising: receiving feedback from the user device regarding the hyperlink between the key point and the most-semantically-relevant segment; responsive to the feedback, adjusting a target of the hyperlink for the key point from the most-semantically-relevant segment to a different segment of the plurality of segments; and updating a machine learning model for the NLP system based, at least in part, on the feedback and the different segment.

Clause 5: The operations described in any of clauses 1-4 or 6-9, wherein the hyperlink is configured to highlight the most-semantically-relevant segment in a user interface among a plurality of segments displayed in the user interface when a representation of the key point in a user interface provided by the user device is selected.

Clause 6: The operations described in any of clauses 1-5 or 7-9, further comprising: identifying, by the NLP system, based, at least in part, on a user profile, an unfamiliar term from the most-semantically-relevant segment; generating a definitional hyperlink between the unfamiliar term in the most-semantically-relevant segment to a definitional description of the unfamiliar term; and transmitting, to the user device with the transcript, the definitional hyperlink and the definitional description.

Clause 7: The operations described in any of clauses 1-6 or 8-9, further comprising: identifying a first segment of the plurality of segments having a relevancy score above a relevancy threshold; and formatting initial display of the transcript in a user interface of the user device to show the first segment of the plurality of segments and not show segments preceding the first segment in the user interface.

Clause 8: The operations described in any of clauses 1-7 or 9, further comprising: analyzing an earlier transcript, by the NLP system, to identify an earlier instance of the key point within an earlier conversation that was analyzed before the conversation; generating a recall hyperlink between the key point and the earlier instance of the key point to link the conversation with the earlier conversation; and transmitting, to the user device, the recall hyperlink with the transcript.

Clause 9: The operations described in any of clauses 1-8, wherein the key point is an appointment, further comprising: generating a reminder in a calendar application associated with the user device based, at least in part, on the appointment.

Clause 10: A method for performing various operations, a system including a processor and a memory device including instructions that when executed by the processor perform various operations, or a memory device that includes instructions that when executed by a processor perform various operations, wherein the operations comprise: receiving a transcript of a conversation between at least a first party and a second party, wherein the transcript includes: a key point classified within a selected semantic category of a plurality of semantic categories identified from the conversation; and a hyperlink between the key point and a most-semantically-relevant segment of a plurality of segments of the transcript; generating a display on a user interface that includes the transcript and the plurality of semantic categories, wherein the selected semantic category includes a selectable representation of the key point; and in response to receiving a selection of the selectable representation via the user interface, adjusting display of the transcript in the user interface to highlight the most-semantically-relevant segment.

Clause 11: The operations described in any of clauses 10 or 12-17, further comprising: presenting in an initial display of the segments of the plurality of segments in the user interface with a first segment of the plurality of segments having a relevancy score above a relevancy threshold and not presenting segments preceding the first segment in the initial display of the user interface.

Clause 12: The operations described in any of clauses 10-11 or 13-17, further comprising: receiving, in the user interface, a dismissal of the most-semantically-relevant segment as linked to the key point; and updating the hyperlink to link the key point with a next-most-semantically-relevant segment.

Clause 13: The operations described in any of clauses 10-12 or 14-17, further comprising: updating a machine learning model of a natural language processing system model used to generate the transcript with feedback based, at least in part, on the next-most-semantically-relevant segment being more relevant to the key point than the most-semantically-relevant segment.

Clause 14: The operations described in any of clauses 10-13 or 15-17, further comprising: receiving, in the user interface, a selection of a different segment as more relevant to the key point than the most-semantically-relevant segment; and updating the hyperlink to link the key point with the different segment.

Clause 15: The operations described in any of clauses 10-14 or 16-17, further comprising: updating a machine learning model of a natural language processing system model used to generate the transcript with feedback based, at least in part, on the different segment being more relevant to the key point than the most-semantically-relevant segment.

Clause 16: The operations described in any of clauses 10-15 or 17, wherein the key point is classified into the selected semantic category based, at least in part, on a user type and selected categories for the plurality of semantic categories selected by the user type.

Clause 17: The operations described in any of clauses 10-16, wherein highlighting the most-semantically-relevant segment includes increasing a size of the most-semantically-relevant segment relative in the user interface relative to other segments displayed in the user interface.

Clause 18: A method for performing various operations, a system including a processor and a memory device including instructions that when executed by the processor perform various operations, or a memory device that includes instructions that when executed by a processor perform various operations, wherein the operations comprise: capturing audio of a conversation including a first plurality of utterances spoken by a first party and a second plurality of utterance spoken by a second party; transmitting the audio to a Natural Language Processing (NLP) system; receiving, from the NLP system, a transcript of the conversation and analysis outputs from the transcript including a key point and hyperlink to a most-semantically-relevant segment of a plurality of segments included in the transcript for the key point as determined by an analysis system linked with a speech recognition system according to a semantic context for the key point within the conversation; displaying, in a User Interface (UI), the transcript and a selectable representation of the key point; and in response to receiving a selection of the selectable representation via the UI, adjusting display of the transcript in the UI to highlight the most-semantically-relevant segment.

Clause 19: Wherein the operations described in clause 18 further comprise, in response to receiving, via the user interface, an edit to a linkage between the key point and the most-semantically-relevant segment: updating a hyperlink associated with the selectable representation to link the key point with a different segment of the plurality of segments instead of the most-semantically-relevant segment.

Clause 20: Wherein the operations described in clause 19 further comprise: updating a training set for a machine learning model used by the analysis system to determine semantic relevancy for transcript segments in relation to key points to include the most-semantically-relevant segment as an not-most-relevant segment specimen.

Embodiments may be implemented as a computer process (method), a computing system, or as an article of manufacture, such as a computer program product or computer-readable storage medium. The computer program product may be a computer-readable storage medium readable by a computer system and encoding a computer program of instructions for executing a computer process. Accordingly, hardware or software (including firmware, resident software, micro-code, etc.) may provide embodiments discussed herein. Embodiments may take the form of a computer program product on a computer-usable or computer-readable storage medium having computer-usable or computer-readable program code embodied in the medium for use by, or in connection with, an instruction execution system.

Although embodiments have been described as being associated with data stored in memory and other storage media, data can also be stored on or read from other types of computer-readable media, such as secondary storage devices, like hard disks, floppy disks, or a CD-ROM, or other forms of RAM or ROM. The term “computer-readable storage medium” refers only to devices and articles of manufacture that store data or computer-executable instructions readable by a computing device. The term “computer-readable storage medium” does not include computer-readable transmission media.

Embodiments described in the present disclosure may be used in various distributed computing environments where tasks are performed by remote processing devices that are linked through a communications network.

The systems, devices, and processors described herein are provided as examples; however, other systems, devices, and processors may comprise the aforementioned memory storage and processing unit, consistent with the described embodiments.

The descriptions and illustrations of one or more embodiments provided herein are intended to provide a thorough and complete disclosure the full scope of the subject matter to those of ordinary skill in the relevant art and are not intended to limit or restrict the scope of the subject matter as claimed in any way. The embodiments, examples, and details provided in this disclosure are considered sufficient to convey possession and enable those of ordinary skill in the relevant art to practice the best mode of the claimed subject matter. Descriptions of structures, resources, operations, and acts considered well-known to those of ordinary skill in the relevant art may be brief or omitted to avoid obscuring lesser known or unique embodiments of the subject matter of this disclosure. The claimed subject matter should not be construed as being limited to any embodiment, aspect, example, or detail provided in this disclosure unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently.

Having been provided with the description and illustration of the present disclosure, one of ordinary skill in the relevant art may envision variations, modifications, and alternate embodiments falling within the spirit of the broader embodiments of the general inventive concept provided in this disclosure that do not depart from the broader scope of the present disclosure.

As used in the present disclosure, a phrase referring to “at least one of” a list of items refers to any set of those items, including sets with a single member, and every potential combination thereof. For example, when referencing “at least one of A, B, and C” or “at least one of A, B, or C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

The following claims are not intended to be limited to the embodiments shown herein, but are to be accorded the full scope consistent with the language of the claims. Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

We claim:

1. A method, comprising:
analyzing a transcript of a conversation, by a Natural Language Processing (NLP) system, to identify a key point and a plurality of segments from the transcript that provide a semantic context for the key point within the conversation;
categorizing, by the NLP system, the key point into a selected category of a plurality of categories for contextual relevance based, at least in part, on the semantic context for the key point;
identifying, by the NLP system, a most-semantically-relevant segment of the plurality of segments;
generating a hyperlink between the key point within the most-semantically-relevant segment of the transcript; and
transmitting, to a user device, the transcript and the hyperlink.

2. The method of claim 1, further comprising, before analyzing the transcript:
receiving an audio recording of the conversation including a first plurality of utterances spoken by a first party and a second plurality of utterances spoken by a second party, wherein the user device is associated with one of the first party or the second party; and
generating, by a speech recognition system of the NLP system, the transcript of the conversation.

3. The method of claim 1, further comprising:
analyzing the transcript, by an analysis system of the NLP system, for a second key point and the segments from the transcript that provide second semantic context for the second key point within the conversation;
categorizing, by the analysis system, the second key point into a second category of the plurality of categories for contextual relevance based on the second semantic context for the second key point;
identifying, by the analysis system, that the most-semantically-relevant segment for the key point is also a most-semantically-relevant second segment for the second key point for categorizing the second key point to the second category;
generating a second hyperlink between the key point within the second category and the most-semantically-relevant second segment of the transcript; and
transmitting, to the user device, the second hyperlink.

4. The method of claim 1, further comprising:
receiving feedback from the user device regarding the hyperlink between the key point and the most-semantically-relevant segment;
responsive to the feedback, adjusting a target of the hyperlink for the key point from the most-semantically-relevant segment to a different segment of the plurality of segments; and
updating a machine learning model for the NLP system based, at least in part, on the feedback and the different segment.

5. The method of claim 1, wherein the hyperlink is configured to highlight the most-semantically-relevant segment in a user interface among a plurality of segments displayed in the user interface when a representation of the key point in a user interface provided by the user device is selected.

6. The method of claim 1, further comprising:
identifying, by the NLP system, based, at least in part, on a user profile, an unfamiliar term from the most-semantically-relevant segment;
generating a definitional hyperlink between the unfamiliar term in the most-semantically-relevant segment to a definitional description of the unfamiliar term; and
transmitting, to the user device with the transcript, the definitional hyperlink and the definitional description.

7. The method of claim 1, further comprising:
identifying a first segment of the plurality of segments having a relevancy score above a relevancy threshold; and
formatting initial display of the transcript in a user interface of the user device to show the first segment of the plurality of segments and not show segments preceding the first segment in the user interface.

8. The method of claim 1, further comprising:
analyzing an earlier transcript, by the NLP system, to identify an earlier instance of the key point within an earlier conversation that was analyzed before the conversation;
generating a recall hyperlink between the key point and the earlier instance of the key point to link the conversation with the earlier conversation; and
transmitting, to the user device, the recall hyperlink with the transcript.

9. The method of claim 1, wherein the key point is an appointment, further comprising:
generating a reminder in a calendar application associated with the user device based, at least in part, on the appointment.

10. A method, comprising:
receiving a transcript of a conversation between at least a first party and a second party, wherein the transcript includes:
a key point classified within a selected semantic category of a plurality of semantic categories identified from the conversation; and
a hyperlink between the key point and a most-semantically-relevant segment of a plurality of segments of the transcript;
generating a display on a user interface that includes the transcript and the plurality of semantic categories, wherein the selected semantic category includes a selectable representation of the key point; and
in response to receiving a selection of the selectable representation via the user interface, adjusting display of the transcript in the user interface to highlight the most-semantically-relevant segment.

11. The method of claim 10, further comprising:
presenting in an initial display of the segments of the plurality of segments in the user interface with a first segment of the plurality of segments having a relevancy score above a relevancy threshold and not presenting segments preceding the first segment in the initial display of the user interface.

12. The method of claim 10, further comprising:
receiving, in the user interface, a dismissal of the most-semantically-relevant segment as linked to the key point; and
updating the hyperlink to link the key point with a next-most-semantically-relevant segment.

13. The method of claim 12, further comprising:
updating a machine learning model of a natural language processing system model used to generate the transcript with feedback based, at least in part, on the next-most-semantically-relevant segment being more relevant to the key point than the most-semantically-relevant segment.

14. The method of claim 10, further comprising:
receiving, in the user interface, a selection of a different segment as more relevant to the key point than the most-semantically-relevant segment; and
updating the hyperlink to link the key point with the different segment.

15. The method of claim 14, further comprising:
updating a machine learning model of a natural language processing system model used to generate the transcript with feedback based, at least in part, on the different segment being more relevant to the key point than the most-semantically-relevant segment.

16. The method of claim 10, wherein the key point is classified into the selected semantic category based, at least in part, on a user type and selected categories for the plurality of semantic categories selected by the user type.

17. The method of claim 10, wherein highlighting the most-semantically-relevant segment includes increasing a size of the most-semantically-relevant segment relative in the user interface relative to other segments displayed in the user interface.

18. A system, comprising:
a processor; and
a memory device including instructions that when executed by the processor perform operations comprising:
capturing audio of a conversation including a first plurality of utterances spoken by a first party and a second plurality of utterance spoken by a second party;
transmitting the audio to a Natural Language Processing (NLP) system;
receiving, from the NLP system, a transcript of the conversation and analysis outputs from the transcript including a key point and hyperlink to a most-semantically-relevant segment of a plurality of segments included in the transcript for the key point as determined by an analysis system linked with a speech recognition system according to a semantic context for the key point within the conversation;
displaying, in a User Interface (UI), the transcript and a selectable representation of the key point; and
in response to receiving a selection of the selectable representation via the UI, adjusting display of the transcript in the UI to highlight the most-semantically-relevant segment.

19. The system of claim 18, wherein the operations further comprise, in response to receiving, via the user interface, an edit to a linkage between the key point and the most-semantically-relevant segment:
updating a hyperlink associated with the selectable representation to link the key point with a different segment of the plurality of segments instead of the most-semantically-relevant segment.

20. The system of claim 19, wherein the operations further comprise:
updating a training set for a machine learning model used by the analysis system to determine semantic relevancy for transcript segments in relation to key points to include the most-semantically-relevant segment as an not-most-relevant segment specimen.
